(19) United States
(12) Patent Application Publication
(10) Pub. No.: US 2011/0164238 A1
(43) Pub. Date: Jul. 7, 2011

(54) EXPOSURE APPARATUS AND DEVICE FABRICATING METHOD

(75) Inventor: Hiromitsu YOSHIMOTO, Saitama-shi (JP)

(73) Assignee: NIKON CORPORATION, Tokyo (JP)

(21) Appl. No.: 12/957,769

(22) Filed: Dec. 1, 2010

Related U.S. Application Data
(60) Provisional application No. 61/282,013, filed on Dec. 2, 2009.

(51) Int. Cl. G03B 27/58

(52) U.S. Cl. 355/72; 355/77

(57) ABSTRACT

An exposure apparatus comprises: a first moving body, which comprises guide members that extend in a first direction, that moves in a second direction, which is substantially orthogonal to the first direction, by the drive of a first drive apparatus; two second moving bodies, which are provided such that they are capable of moving independently in the first direction along the guide members, that move in the second direction together with the guide members by the movement of the first moving body; a holding member, which holds an object W and is supported by the two second moving bodies such that it is capable of moving within a two dimensional plane that includes at least the first direction and the second direction as well as a first position directly below an optical system; and a liquid holding member that is disposed adjacent to the two second moving bodies in the second direction, moves together with the holding member, which is supported by the two second moving bodies, in a direction parallel to the second direction by the drive of a second drive apparatus, which shares at least one part of the first drive apparatus, while maintaining the state wherein the liquid holding member is in close proximity or in contact at its end part on one of the second direction sides, and causes a transition from a first state, wherein a liquid is held between the object on the holding member and the optical system, to a second state, wherein the liquid is held between the liquid holding member and the optical system.

### CROSS-REFERENCE TO RELATED APPLICATION

This application is a non-provisional application claiming priority to and the benefit of U.S. provisional application. No. 61/282,013, filed on Dec. 2, 2009. The entire contents of which are incorporated herein by reference.

### BACKGROUND

The present invention relates to an exposure apparatus and a device fabricating method.

Conventionally, lithographic processes that fabricate electronic devices (i.e., microdevices), such as semiconductor devices (i.e., integrated circuits and the like) and liquid crystal display devices, principally use step-and-repeat type projection exposure apparatuses (i.e., so-called steppers), step-and-scan type projection exposure apparatuses (i.e., so-called scanning steppers or scanners), or the like.

Wafers that undergo exposure and substrates like glass plates that are used in various exposure apparatuses have been increasing in size with time (e.g., wafers have increased in size every 10 years). Presently, the mainstream wafer has a diameter of 300 mm, and the era of a wafer with a diameter of 450 mm is nearing. When the industry transitions to the 450 mm wafer, the number of dies (i.e., chips) yielded by one wafer will increase to more than double that of the current 300 mm wafer, which will help reduce costs. In addition, it is anticipated that the effective utilization of energy, water, and other resources will further reduce the total resources consumed per chip.

The increasing miniaturization of semiconductor devices over time has created a demand for exposure apparatuses with greater resolving power. Means of improving resolving power include shortening the wavelength of the exposure light and increasing the numerical aperture of the projection optical system (i.e., increasing NA). Using an immersion exposure, wherein a wafer is exposed through the projection optical system and a liquid, effectively maximizes the effective numerical aperture of that projection optical system.

Moreover, given that increasing the size of the wafer to 450 mm will also increase the number of dies (i.e., chips) yielded by one wafer, it is highly probable that the time required to expose one wafer will increase commensurately, thereby reducing throughput. Accordingly, throughput must be improved as much as possible; one conceivable method of doing so is to adopt a twin stage system wherein an exposing process is performed on a wafer on one wafer stage while another process, such as a wafer exchanging process or a wafer aligning process, is performed on a separate wafer stage.

Namely, to simultaneously improve resolving power and throughput, it is conceivable to adopt a local liquid immersion type exposure apparatus that is configured with twin stages. The exposure apparatus disclosed in, for example, U.S. Patent Application Publication No. 2008/0088843 is one known conventional example of such an exposure apparatus.

### SUMMARY

To maximize throughput in the local liquid immersion type exposure apparatus disclosed in U.S. Patent Application Publication No. 2008/0088843, it is necessary to maintain an immersion space, which is formed below a projection optical system, continuously; consequently, it is necessary to constantly and replaceably dispose some kind of member directly below the projection optical system. Accordingly, it is preferable that the replaceable arrangement of this member contribute to improving the throughput of the apparatus.

In addition, providing a separate drive apparatus to drive this replaceable member risks increasing the size and cost of the apparatus.

This risk is not limited to twin stage type exposure apparatuses, but equally pertains to exposure apparatuses with only one stage.

A purpose of aspects of the present invention is to provide an exposure apparatus and a device fabricating method that can help improve throughput and prevent increases in cost.

An exposure apparatus according to an aspect of the present invention is an exposure apparatus that exposes an object with an energy beam through an optical system and a liquid and comprises: a first moving body, which comprises guide members that extend in a first direction, that moves in a second direction, which is substantially orthogonal to the first direction, by the drive of a first drive apparatus; two second moving bodies, which are provided such that they are capable of moving independently in the first direction along the guide members, that move in the second direction together with the guide members by the movement of the first moving body; a holding member, which holds the object and is supported by the two second moving bodies such that it is capable of moving within a two dimensional plane that includes at least the first direction and the second direction as well as a first position directly below the optical system; and a liquid holding member that is disposed adjacent to the two second moving bodies in the second direction, moves together with the holding member, which is supported by the two second moving bodies, in a direction parallel to the second direction by the drive of a second drive apparatus, which shares at least one part of the first drive apparatus, while maintaining the state wherein the liquid holding member is in close proximity or in contact at its end part on one of the second direction sides, and causes a transition from a first state, wherein the liquid is held between the object on the holding member and the optical system, to a second state, wherein the liquid is held between the liquid holding member and the optical system.

A device fabricating method according to another aspect of the present invention is a device fabricating method that comprises the steps of: exposing an object using an exposure apparatus according to the present invention; and developing the exposed object.

Aspects of the present invention can improve the throughput of a local liquid immersion type exposure apparatus while preventing an increase in the size and cost of the apparatus.

### BRIEF DESCRIPTION OF THE DRAWINGS

FIG. 1 schematically shows the configuration of an exposure apparatus of one embodiment.

FIG. 2 is a schematic oblique view of a stage apparatus provided by the exposure apparatus shown in FIG. 1.

FIG. 3 is an exploded oblique view of the stage apparatus shown in FIG. 2.

FIG. 4A is a side view, viewed from the −Y direction, that shows the stage apparatus provided by the exposure apparatus shown in FIG. 1.

FIG. 4B is a plan view that shows the stage apparatus.

FIG. 5 is a block diagram that shows the configuration of a control system of the exposure apparatus shown in FIG. 1.

FIG. 6 is a plan view that shows the arrangement of magnet units and a coil unit that constitute a fine motion stage drive system.

FIG. 7A is a view for explaining the operation performed when a fine motion stage is rotated around the Z axis with respect to coarse motion stages.

FIG. 7B is a view for explaining the operation performed when the fine motion stage is rotated around the Y axis with respect to the coarse motion stages.

FIG. 7C is a view for explaining the operation performed when the fine motion stage is rotated around the X axis with respect to the coarse motion stages.

FIG. 8 is a view for explaining the operation performed when a center part of the fine motion stage is flexed in the +Z direction.

FIG. 9A is an oblique view that shows a tip part of a measuring arm.

FIG. 9B is a plan view, viewed from the +Z direction, of the upper surface of the tip part of the measuring arm.

FIG. 10A is a block diagram of an X head.

FIG. 10B is for explaining the arrangement of the X head and Y head inside the measuring arm.

FIG. 11A is a view for explaining a method of driving a wafer during a scanning exposure.

FIG. 11B is for explaining a method of driving the wafer during stepping.

FIG. 12 is for explaining the transfer of an immersion space (i.e., a liquid Lq) between the fine motion stage and a measurement stage.

FIG. 13 is for explaining the transfer of the immersion space (i.e., the liquid Lq) between the fine motion stage and the measurement stage.

FIG. 14 is for explaining the transfer of the immersion space (i.e., the liquid Lq) between the fine motion stage and the measurement stage.

FIG. 15A is a view for explaining the measurement of the relative position of the fine motion stage and the measurement stage in the Y directions.

FIG. 15B is a views for explaining the measurement of the relative position of the fine motion stage and the measurement stage in the Y directions.

FIG. 16 is a view that shows an exposure apparatus according to a modified example.

FIG. 17 is a block diagram that shows the configuration of a control system of the exposure apparatus.

FIG. 18 is a schematic oblique view of a stage apparatus that has two stage units.

FIG. 19 is a view that shows a separate embodiment of a liquid holding member.

FIG. 20 shows the arrangement of a grating according to a modified example.

FIG. 21 is a flow chart that depicts one example of a process of fabricating a microdevice of the present invention.

FIG. 22 depicts one example of the detailed process of step S13 described in FIG. 21.

### DESCRIPTION OF EMBODIMENTS

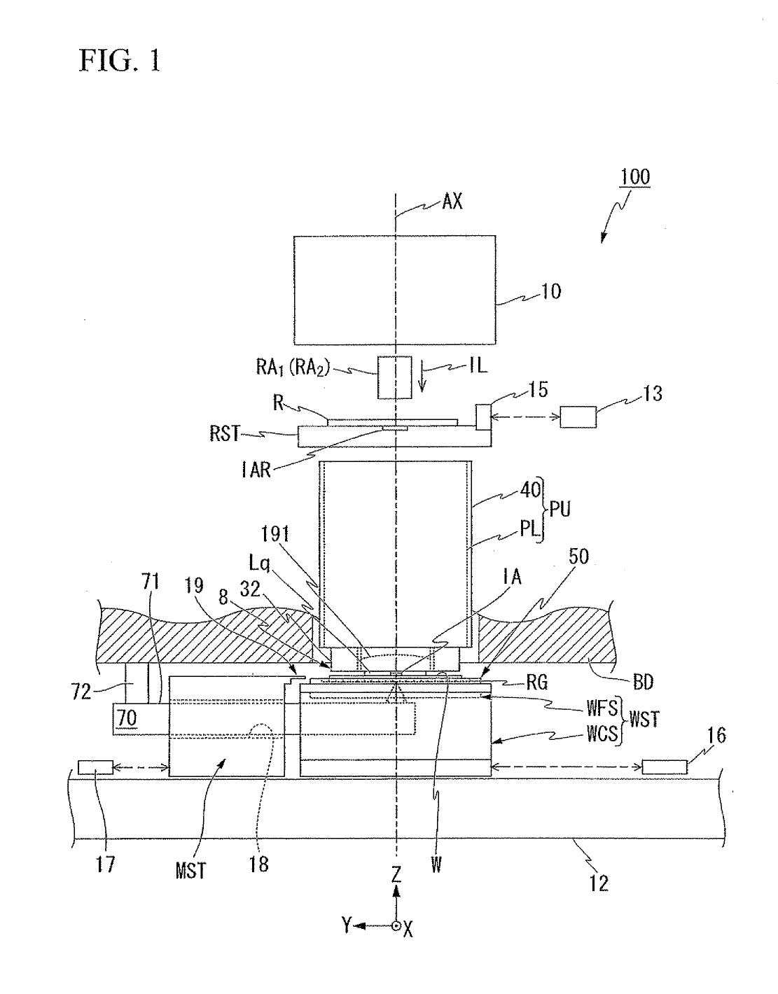

The following text explains embodiments of an exposure apparatus and a device fabricating method of the present invention, referencing FIG. 1 through FIG. 22.

FIG. 1 schematically shows the configuration of an exposure apparatus 100 according to one embodiment. The exposure apparatus 100 is a step-and-scan-type projection exposure apparatus, namely, a so-called scanner. In the present embodiment as discussed below, a projection optical system PL is provided; furthermore, in the explanation below, the directions parallel to an optical axis AX of the projection optical system PL are the Z axial directions, the directions within a plane that is orthogonal thereto and wherein a reticle and a wafer are scanned relative to one another are the Y axial directions, the directions that are orthogonal to the Z axis and the Y axis are the X axial directions, and the rotational (i.e., tilt) directions around the X axis, the Y axis, and the Z axis are the θx, the θy, and the θz directions, respectively.

The exposure apparatus 100 comprises an illumination system 10, a reticle stage RST, a projection unit PU, a local liquid immersion apparatus 8, a stage apparatus 50 that has a fine motion stage WFS and a measurement stage MST, and a control system that controls these elements. In FIG. 1, a wafer W is mounted on the fine motion stage WFS.

As disclosed in, for example, U.S. Patent Application Publication No. 2003/0025890, the illumination system 10 comprises a light source and an illumination optical system that comprises: a luminous flux intensity uniformizing optical system, which includes an optical integrator and the like; and a reticle blind (none of which are shown). The illumination system 10 illuminates, with illumination light IL (i.e., exposure light) at a substantially uniform luminous flux intensity, a slit shaped illumination area IAR, which is defined by a reticle blind (also called a masking system), on a reticle R. Here, as one example, ArF excimer laser light (with a wavelength of 193 nm) is used as the illumination light IL.

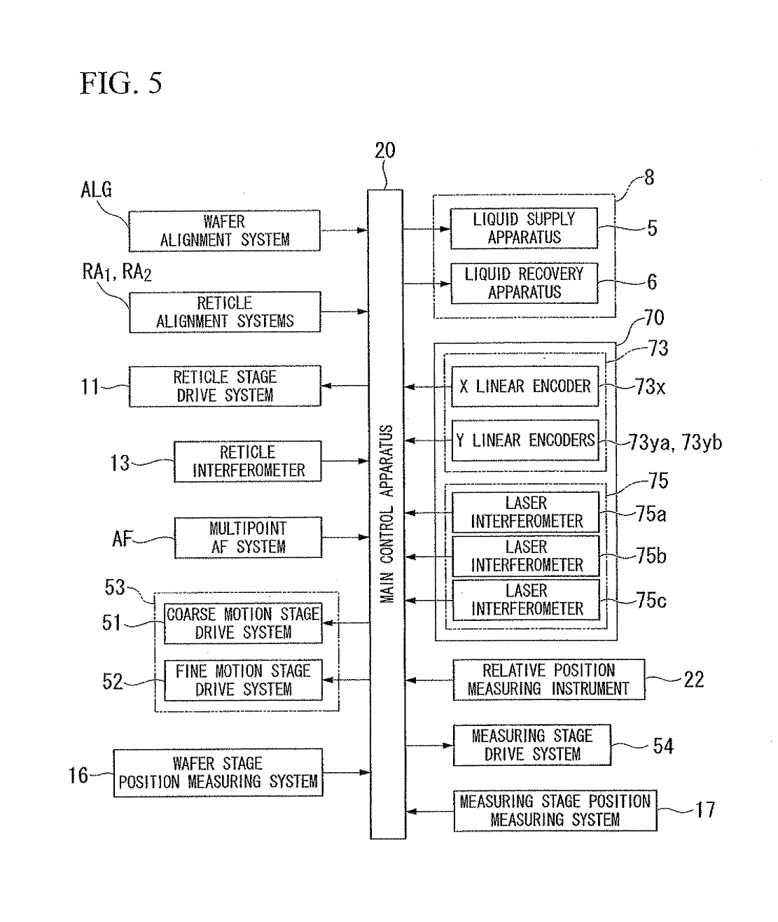

The reticle R, whose patterned surface (i.e., in FIG. 1, a lower surface) has a circuit pattern and the like formed thereon, is fixed onto the reticle stage RST by, for example, vacuum chucking. A reticle stage drive system 11 (not shown in FIG. 1; refer to FIG. 5) that comprises, for example, linear motors is capable of driving the reticle stage RST finely within an XY plane and at a prescribed scanning speed in scanning directions (i.e., in the Y axial directions, which are the lateral directions within the paper plane of FIG. 1).

A reticle laser interferometer 13 (hereinbelow, called a “reticle interferometer”) continuously detects, with a resolving power of, for example, approximately 0.25 nm, the position within the XY plane (including rotation in the θz directions) of the reticle stage RST via movable minors 15, which are fixed to the reticle stage RST. Measurement values of the reticle interferometer 13 are sent to a main control apparatus 20 (not shown in FIG. 1; refer to FIG. 5).

The projection unit PU is disposed below the reticle stage RST in FIG. 1. The projection unit PU comprises a lens barrel 40 and the projection optical system PL, which comprises a plurality of optical elements that are held inside the lens barrel 40. A dioptric optical system that is, for example, double telecentric and has a prescribed projection magnification (e.g., ¼×, ⅕×, or ⅛×) is used as the projection optical system PL. Consequently, when the illumination light IL that emerges from the illumination system 10 illuminates the illumination area TAR on the reticle R, the illumination light IL that passes through the reticle R, whose patterned surface is disposed substantially coincident with a first plane (i.e., the object plane) of the projection optical system PL, travels through the projection optical system PL (i.e., the projection unit PU) and forms a reduced image of a circuit pattern of the reticle R that lies within that illumination area JAR (i.e., a reduced image of part of the circuit pattern) on the wafer W, which is disposed on a second plane side (i.e., the image plane side) of the projection optical system PL and whose front surface is coated with a resist (i.e., a sensitive agent), in an area IA (hereinbelow, also called an “exposure area”) that is conjugate with the illumination area IAR. Furthermore, by synchronously scanning the reticle stage RST and the fine motion stage WFS, the reticle R is moved relative to the illumination area TAR (i.e., the illumination light IL) in one of the scanning directions (i.e., one of the Y axial directions) and the wafer W is moved relative to the exposure area IA (i.e., the illumination light IL) in the other scanning direction (i.e., the other Y axial direction); thereby, a single shot region (i.e., block area) on the wafer W undergoes a scanning exposure and the pattern of the reticle R is transferred to that shot region. Namely, in the present embodiment, the pattern of the reticle R is created on the wafer W by the illumination system 10 and the projection optical system PL, and that pattern is formed on the wafer W by exposing a sensitive layer (i.e., a resist layer) on the wafer W with the illumination light IL.

The local liquid immersion apparatus 8 comprises a liquid supply apparatus 5 and a liquid recovery apparatus 6 (both of which are not shown in FIG. 1; refer to FIG. 5) as well as a nozzle unit 32. As shown in FIG. 1, the nozzle unit 32 is suspended from a main frame BD, which supports the projection unit PU and the like, via a support member (not shown) such that the nozzle unit 32 surrounds a lower end part of the lens barrel 40 that holds the optical element—of the optical elements that constitute the projection optical system PL—that is most on the image plane side (i.e., the wafer W side), here, a lens 191 (hereinbelow, also called a “tip lens”). In the present embodiment, the main control apparatus 20 controls both the liquid supply apparatus 5 (refer to FIG. 5), which via the nozzle unit 32 supplies a liquid Lq to the space between the tip lens 191 and the wafer W, and the liquid recovery apparatus 6 (refer to FIG. 5), which via the nozzle unit 32 recovers the liquid from the space between the tip lens 191 and the wafer W. At this time, the main control apparatus 20 controls the liquid supply apparatus 5 and the liquid recovery apparatus 6 such that the amount of the liquid supplied and the amount of the liquid recovered are always equal. Accordingly, a fixed amount of a liquid Lq (refer to FIG. 1) is always being replaced and held between the tip lens 191 and the wafer W. In the present embodiment, it is understood that pure water, through which ArF excimer laser light (i.e., light with a wavelength of 193 nm) transmits, is used as the abovementioned liquid.

As shown in FIG. 1, the stage apparatus 50 comprises: a base plate 12, which is supported substantially horizontally by a vibration isolating mechanism (not illustrated) on a floor surface; a wafer stage WST, which holds the wafer W and moves on the base plate 12; a wafer stage drive system 53 (refer to FIG. 5), which drives the wafer stage WST; the measurement stage MST (i.e., the liquid holding member), which moves on the base plate 12; a measurement stage drive system 54 (refer to FIG. 5), which drives the measurement stage MST; and various measurement systems (16, 70) (refer to FIG. 5).

The base plate 12 comprises a member whose outer shape is shaped as a flat plate and whose upper surface is finished to an extremely high degree of flatness and serves as a guide surface when the wafer stage WST is moved.

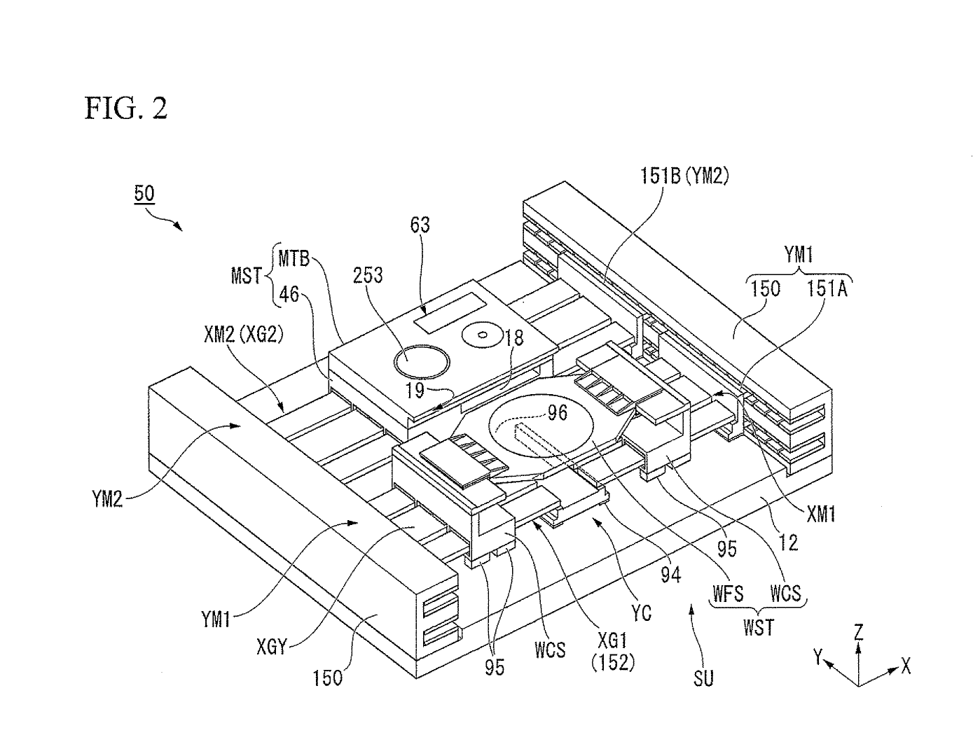

As shown in FIG. 2, the stage apparatus 50 comprises: a Y coarse motion stage YC (i.e., a first moving body), which moves by the drive of Y motors YM1 (i.e., first drive apparatuses); two X coarse motion stages WCS (i.e., second moving bodies), which move independently by the drive of X motors XM1; the fine motion stage WFS (i.e., the holding member) which holds the wafer W and is moveably supported by the X coarse motion stages WCS; and the measurement stage MST, which moves in the X directions by the drive of X motors XM2 together with the movement in the Y directions by the drive of Y motors YM2 (i.e., second drive apparatuses). The Y coarse motion stage YC and the X coarse motion stages WCS constitute a stage unit SU. In addition, the Y motors YM1 and the X motors XM1 collectively constitute a coarse motion stage drive system 51 (refer to FIG. 5). In addition, the Y motors YM2 and the X motors XM2 collectively constitute the measurement stage drive system 54 (refer to FIG. 5).

The pair of X coarse motion stages WCS and the fine motion stage WFS constitute the wafer stage WST discussed above. The fine motion stage WFS is driven by a fine motion stage drive system 52 (refer to FIG. 5) in the X, Y, Z, θx, θy, and θz directions, which correspond to six degrees of freedom, with respect to the X coarse motion stages WCS. In the present embodiment, the coarse motion stage drive system 51 and the fine motion stage drive system 52 constitute the wafer stage drive system 53.

When the fine motion stage WFS is supported by the X coarse motion stages WCS, a relative position measuring instrument 22 (refer to FIG. 5), which is provided between the coarse motion stages WCS and the fine motion stage WFS, can measure the relative position of the fine motion stage WFS and the coarse motion stages WCS in the X, Y, and θz directions, which correspond to three degrees of freedom.

It is possible to use as the relative position measuring instrument 22, for example, an encoder wherein a grating provided to the fine motion stage WFS serves as a measurement target, the X coarse motion stages WCS are each provided with at least two heads, and the position of the fine motion stage WFS in the X axial, Y axial, and θz directions is measured based on the outputs of these heads. The measurement results of the relative position measuring instrument 22 are supplied to the main control apparatus 20 (refer to FIG. 5).

The configuration and the like of the wafer stage position measuring system 16, the fine motion stage position measuring system 70, and each part of the stage apparatus 50 will be discussed in detail later.

In the exposure apparatus 100, a wafer alignment system ALG (not shown in FIG. 1; refer to FIG. 5) is disposed at a position at which it is spaced apart by a prescribed distance from the center of the projection unit PU on the +Y side thereof. For example, an image processing type field image alignment (FIA) system is used as the alignment system ALG. When a wafer alignment (e.g., an enhanced global alignment (EGA)) is performed, the main control apparatus 20 uses the wafer alignment system ALG to detect a second fiducial mark, which is formed in a measuring plate (discussed later) on the fine motion stage WFS, or an alignment mark on the wafer W. The captured image signal output by the wafer alignment system ALG is supplied to the main control apparatus 20 via a signal processing system (not shown). During the alignment of the target mark, the main control apparatus 20 calculates the X and Y coordinates in a coordinate system based on the results of the detection of the wafer alignment system ALG (i.e., the results of the captured image) and the position of the fine motion stage WFS (i.e., the wafer W) during the detection.

In addition, in the exposure apparatus 100 of the present embodiment, an oblique incidence type multipoint focus position detection system AF (hereinbelow, abbreviated as “multipoint AF system”; not shown in FIG. 1; refer to FIG. 5), which is configured identically to the one disclosed in, for example, U.S. Pat. No. 5,448,332, is provided in the vicinity of the projection unit PU. The detection signal of the multipoint AF system AF is supplied to the main control apparatus 20 (refer to FIG. 5) via an AF signal processing system (not shown). The main control apparatus 20 detects, based on the detection signal output by the multipoint AF system AF, the position of the front surface of the wafer W in the Z axial directions at each detection point of a plurality of detection points of the multipoint AF system AF (i.e., the surface position information) and, based on the results of that detection, performs a so-called focus and leveling control on the wafer W during the scanning exposure. Furthermore, the multipoint AF system may be provided in the vicinity of the wafer alignment system ALG, the surface position information (i.e., nonuniformity information) of the front surface of the wafer W during wafer alignment (EGA) may be acquired beforehand, and the so-called focus and leveling control may be performed on the wafer W during an exposure using the surface position information and a measurement value of a laser interferometer system 75 (refer to FIG. 5), which constitutes part of the fine motion stage position measuring system 70 (discussed below).

In addition, a pair of image processing type reticle alignment systems RA₁, RA₂ (in FIG. 1, the reticle alignment system RA₂ is hidden on the paper plane far side of the reticle alignment system RA₁), each of which uses light (in the present embodiment, the illumination light IL) of the exposure wavelength as the illumination light for alignment, is disposed above the reticle stage RST, as disclosed in detail in, for example, U.S. Pat. No. 5,646,413. The detection signals of the reticle alignment systems RA₁, RA₂ are supplied to the main control apparatus 20 (refer to FIG. 5) via a signal processing system (not shown).

FIG. 5 shows the principal components of the control system of the exposure apparatus 100. The heart of the control system is the main control apparatus 20. The main control apparatus 20 is, for example, a workstation (or a microcomputer) that supervisorally controls each constituent part of the exposure apparatus 100 such as the local liquid immersion apparatus 8, the coarse motion stage drive system 51, and the fine motion stage drive system 52, all of which are discussed above.

In addition, in the exposure apparatus 100 of the present embodiment, the pair of image processing type reticle alignment systems RA₁, RA₂ (in FIG. 1, the reticle alignment system RA₂ is hidden on the paper plane far side of the reticle alignment system RA₁) is disposed above the reticle stage RST; furthermore, each of the processing type reticle alignment systems RA₁, RA₂ comprises an image capturing device such as a CCD and uses light (in the present embodiment, the illumination light IL) of the exposure wavelength as the illumination light for alignment, as disclosed in detail in, for example, U.S. Pat. No. 5,646,413. In a state wherein a measuring plate (discussed below) is positioned on the fine motion stage WFS directly below the projection optical system PL, the main control apparatus 20 uses the pair of reticle alignment systems RA₁, RA₂ to detect, through the projection optical system PL, a pair of first fiducial marks on the measuring plate corresponding to a projected image of a pair of reticle alignment marks (not illustrated) formed on the reticle R; thereby, the positional relationship between the center of the projection area of the pattern of the reticle R formed by the projection optical system PL and the reference positions on the measuring plate, namely, the centers of the two first fiducial marks, is detected. The detection signals of the reticle alignment systems RA₁, RA₂ are supplied to the main control apparatus 20 (refer to FIG. 5) via a signal processing system (not shown).

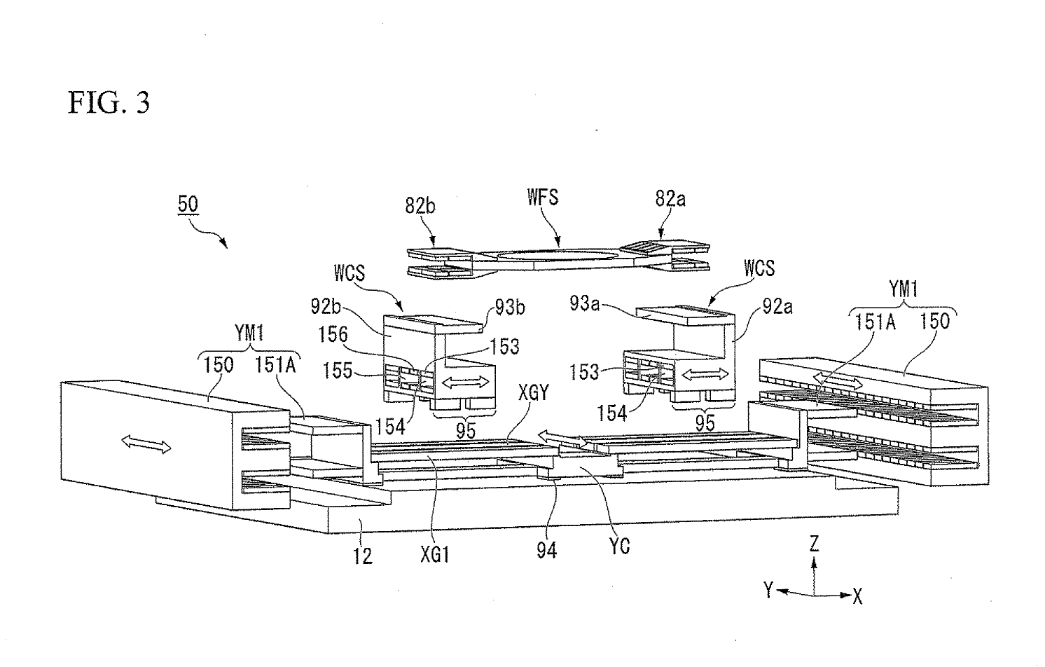

Continuing, the configuration and the like of each part of the stage apparatus 50 will now be discussed in detail, referencing FIG. 2 and FIG. 3.

The Y motors YM1 comprise stators 150, which are provided on both side ends of the base plate 12 in the X directions such that they extend in the Y directions, and sliders 151A, which are provided on both ends of the Y coarse motion stage YC in the X directions. The Y motors YM2 comprise the abovementioned stators 150 and sliders 151B, which are provided on both ends of the Y coarse motion stage YC2 in the X directions. Namely, the Y motors YM1, YM2 are configured such that they share the stators 150. The stators 150 comprise permanent magnets, which are arrayed in the Y directions, and the sliders 151A, 151B comprise coils, which are arrayed in the Y directions. Namely, the Y motors YM1, YM2 are moving coil type linear motors that drive the wafer stage WST, the measurement stage MST, and the Y coarse motion stage YC in the Y directions. Furthermore, while the above text explains an exemplary case of moving coil type linear motors, the linear motors may be moving magnet type linear motors.

In addition, aerostatic bearings (not shown), for example, air bearings, which are provided to the lower surfaces of the stators 150, levitationally support the stators 150 above the base plate 12 with a prescribed clearance. Thereby, the reaction force generated by the movement of the wafer stage WST, the measurement stage MST, the Y coarse motion stage YC, and the like in either one of the Y directions moves the stators 150, which serve as Y countermasses in the Y directions, in the other Y direction and is thereby offset by the law of conservation of momentum.

X guides XG2 (i.e., guide members), which extend in the X directions, are provided between the sliders 151B, 151B, and the measurement stage MST moves along the X guides XG2 by the drive of the X motors XM2. The measurement stage MST comprises a measurement stage main body 46, which is disposed on the base plate 12, and a measurement table MTB, which is mounted on the measurement stage main body 46. The measurement table MTB is formed from, for example, a low thermal expansion material, such as Zerodur® made by Schott Nippon K.K., and its upper surface is liquid repellent (e.g., water repellent). The measurement table MTB is held on the measurement stage main body 46 by, for example, vacuum chucking, and is configured so that it is exchangeable.

In addition, the measurement stage MST is disposed adjacent to and on the +Y side of the wafer stage WST and comprises a projection part 19, which projects from the −Y side upper end part of the measurement stage MST (refer to FIG. 1, FIG. 2, and the like). The height of the front surface of the measurement table MTB that includes the projection 19 is set such that it is substantially the same as the height of the front surface of the fine motion stage WFS.

The main control apparatus 20 uses a measurement stage position measuring system 17 (refer to FIG. 1 and FIG. 5) to measure the position of the measurement stage MST. As shown in FIG. 1, the measurement stage position measuring system 17 comprises laser interferometers, which radiate length measurement beams to reflective surfaces on the side surfaces of the measurement stage MST, and measures the position within the XY plane (including the rotation in the θz directions) of the measurement stage MST.

In addition, the measurement stage MST further comprises a measuring instrument group for performing various measurements related to the exposure. Examples of measuring instruments in the measuring instrument group include an aerial image measuring apparatus, a wavefront aberration measuring apparatus, and an exposure detection apparatus. The aerial image measuring apparatus measures an aerial image, which the projection optical system PL projects onto the measurement table MTB through the water. In addition, the wavefront aberration measuring apparatus disclosed in, for example, PCT International Publication WO99/60361 (and corresponding European Patent No. 1,079,223) can be used as the abovementioned wavefront aberration measuring apparatus.

In addition, the exposure detection apparatus is a detection apparatus that obtains information (for example, the amount of light, the luminous flux intensity, and the luminous flux intensity nonuniformity) related to the exposure energy of the exposure light that is radiated onto the measurement table MTB through the projection optical system PL, and it is possible to use as the exposure detection apparatus a luminous flux intensity nonuniformity measuring instrument as disclosed in, for example, Japanese Published Unexamined Patent Application No. 557-117238 (and corresponding U.S. Pat. No. 4,465,368) or a luminous flux intensity monitor as disclosed in, for example, Japanese Published Unexamined Patent Application No. H11-16816 (and corresponding U.S. Patent Application Serial No. 2002/0061469). Furthermore, in FIG. 2, the aerial image measuring apparatus, the wavefront aberration measuring apparatus, and the exposure detection apparatus that were explained above are shown as a measuring instrument group 63.

Furthermore, a fiducial plate 253, wherein various marks used by the measuring instrument group or the alignment process are formed, is provided at a prescribed position to the upper surface of the measurement table MTB. This fiducial plate 253 is formed from a low thermal expansion material, its upper surface is liquid repellent (e.g., water repellent), and it is configured so that it is exchangeable, that is, an existing one can be removed from the measurement table MTB and a new one disposed thereon.

The Y coarse motion stage YC comprises X guides XG1 (i.e., guide members), which are provided between the sliders 151A, 151A and extend in the X directions, and is levitationally supported above the base plate 12 by a plurality of noncontact bearings, for example, air bearings 94, that is provided to a bottom surface of the Y coarse motion stage YC.

The X guides XG1 are provided with stators 152, which constitute the X motors XM1. As shown in FIG. 3, sliders 153 of the X motors XM1 are provided in through holes 154, wherethrough the X guides XG1 are inserted and that pass through the X coarse motion stages WCS in the X directions.

The two X coarse motion stages WCS are each levitationally supported above the base plate 12 by a plurality of noncontact bearings, for example, air bearings 95, provided to the bottom surfaces of the X coarse motion stages WCS and move in the X directions independently of one another along the X guides XG1 by the drive of the X motors XM1. The Y coarse motion stage YC is provided with, in addition to the X guides XG1, X guides XGY whereto the stators of the Y linear motors YM1 that drive the X coarse motion stages WCS in the Y directions are provided. Furthermore, in each of the X coarse motion stages WCS, a slider 156 of the Y linear motor is provided in a through hole 155 (refer to FIG. 3), which passes through the X coarse motion stages WCS in the X directions. Furthermore, a configuration may be adopted wherein the X coarse motion stages WCS are supported in the Y directions by providing air bearings instead of providing the Y linear motors.

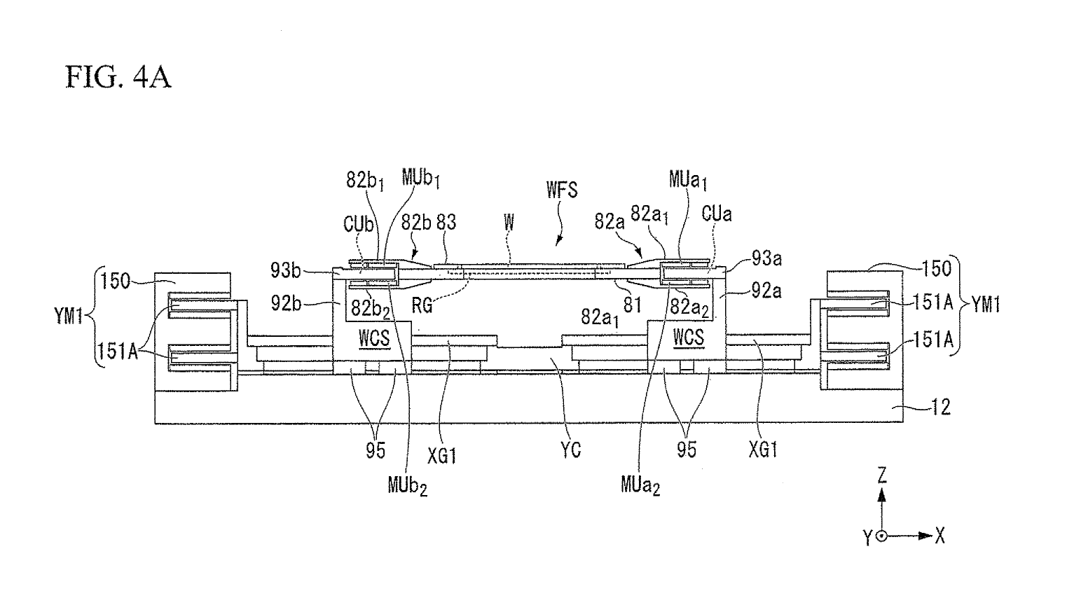

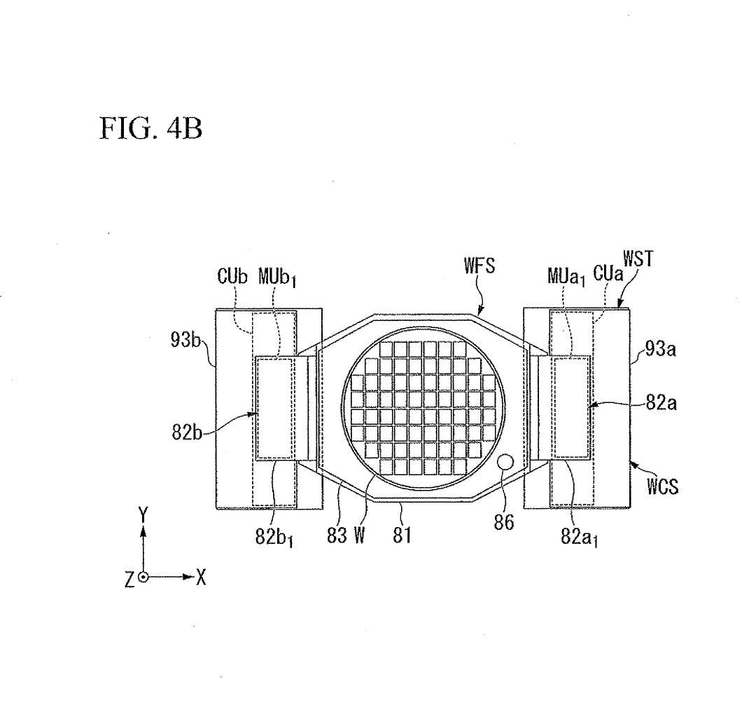

FIG. 4A is a side view, viewed from the −Y direction, of the stage apparatus 50, and FIG. 4B is a plan view of the stage apparatus 50. As shown in FIG. 4A and FIG. 4B, a pair of sidewall parts 92a, 92b and a pair of stator parts 93a, 93b, which are fixed to the upper surfaces of the sidewall parts 92a, 92b, are provided to the outer side end parts in the X directions of the X coarse motion stages WCS. As a whole, each of the coarse motion stages WCS has a box shape with a small height and that is open at the center part of the upper surface in the X axial directions and both side surfaces in the Y axial directions. Namely, a space is formed in each of the coarse motion stages WCS such that the space passes through the inner part of the coarse motion stages WCS in the Y axial directions.

Each of the stator parts 93a, 93b is a member whose outer shape is shaped as a plate; furthermore, the stator parts 93a, 93b respectively house coil units CUa, CUb, which are for driving the fine motion stage WFS. The main control apparatus 20 controls the magnitude and direction of each electric current supplied to the coils that constitute the coil units CUa, CUb. The configuration of the coil units CUa, CUb will be discussed further below.

The +X side end part of the stator part 93a is fixed to the upper surface of the sidewall part 92a, and the −X side end part of the stator part 93b is fixed to the upper surface of the sidewall part 92b.

As shown in FIG. 4A and FIG. 4B, the fine motion stage WFS comprises a main body part 81, which consists of an octagonal plate shaped member whose longitudinal directions are oriented in the X axial directions in a plan view, and two slider parts 82a, 82b, which are fixed to one end part and an other end part of the main body part 81 in the longitudinal directions.

Because an encoder system measurement beam (i.e., measurement light), which is discussed below, must be able to travel through the inner part of the main body part 81, the main body part 81 is formed from a transparent raw material wherethrough light can transmit. In addition, to reduce the effects of air turbulence on the measurement beam that passes through the inner part of the main body part 81, the main body part 81 is formed as a solid block (i.e., its interior has no space). Furthermore, the transparent raw material preferably has a low coefficient of thermal expansion; in the present embodiment, as one example, synthetic quartz (i.e., glass) is used. Furthermore, although the entire main body part 81 may be formed from the transparent material, a configuration may be adopted wherein only the portion wherethrough the measurement beam of the encoder system transmits is formed from the transparent raw material; furthermore, a configuration may be adopted wherein only the latter is formed as a solid.

A wafer holder (not shown), which holds the wafer W by vacuum chucking or the like, is provided at the center of the upper surface of the main body part 81 of the fine motion stage WFS. Furthermore, the wafer holder may be formed integrally with the fine motion stage WFS and may be fixed to the main body part 81 by bonding and the like or via, for example, an electrostatic chuck mechanism or a clamp mechanism.

Furthermore, as shown in FIG. 4A and FIG. 4B, a circular opening whose circumference is larger than the wafer W (i.e., the wafer holder) is formed in the center of the upper surface of the main body part 81 on the outer side of the wafer holder (i.e., the mounting area of the wafer W), and a plate 83 (i.e., a liquid repellent plate), whose octagonal outer shape (i.e., contour) corresponds to the main body part 81, is attached to the upper surface of the main body part 81. The front surface of the plate 83 is given liquid repellency treatment (i.e., a liquid repellent surface is formed) such that it is liquid repellent with respect to the liquid Lq. The plate 83 is fixed to the upper surface of the main body part 81 such that the entire front surface (or part of the front surface) of the plate 83 is coplanar with the front surface of the wafer W. In addition, as shown in FIG. 4B, a circular opening is formed in one end part of the plate 83 and a measuring plate 86 is embedded in that opening in the state wherein the front surface of the measuring plate 86 is substantially coplanar with the front surface of the plate 83, namely, the front surface of the wafer W. At least a pair of the first fiducial marks discussed above and the second fiducial mark, which is detected by the wafer alignment system ALG, are formed in the front surface of the measuring plate 86 (note that none of the first and second fiducial marks are shown).

As shown in FIG. 4A, a two-dimensional grating RG (hereinbelow, simply called a “grating”) that serves as a measurement surface is disposed horizontally (i.e., parallel to the front surface of the wafer W) on the upper surface of the main body part 81 in an area whose circumference is larger than the wafer W. The grating RG comprises a reflective diffraction grating whose directions of periodicity are oriented in the X axial directions (i.e., an X diffraction grating) and a reflective diffraction grating whose directions of periodicity are oriented in the Y axial directions (i.e., a Y diffraction grating).

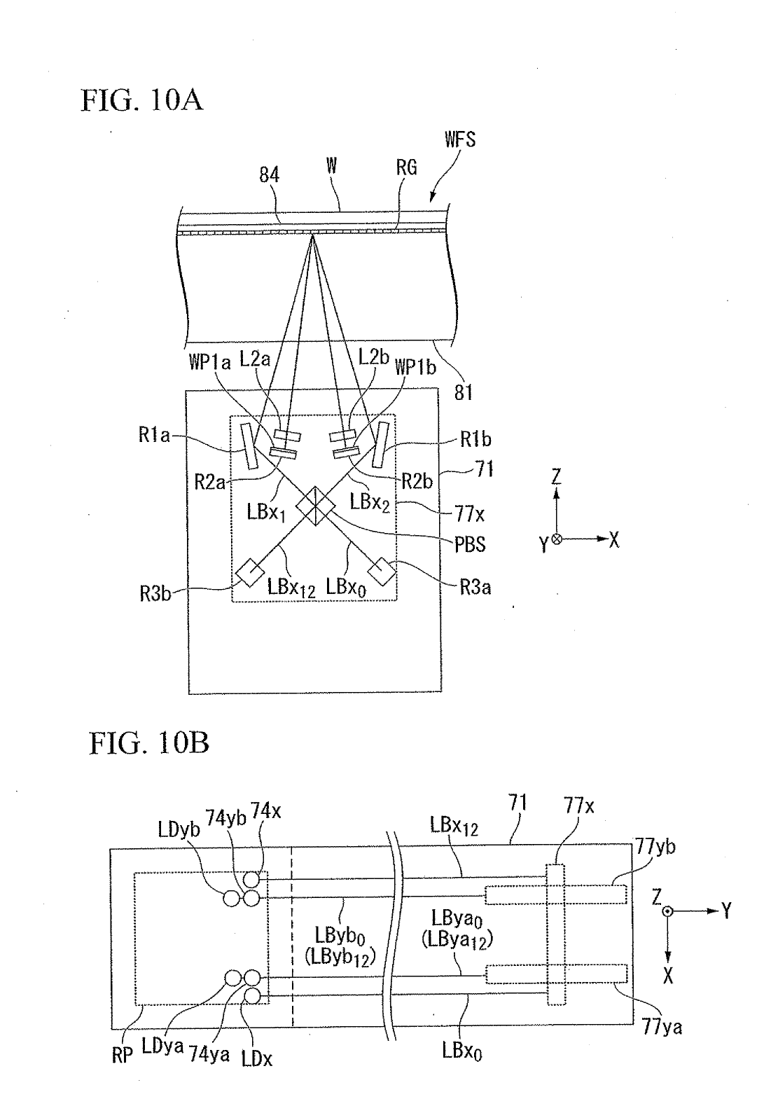

The upper surface of the grating RG is covered by a protective member, for example, a cover glass 84 (FIG. 10A). In the present embodiment, the electrostatic chucking mechanism (discussed above), which chucks the wafer holder, is provided to the upper surface of the cover glass 84. Furthermore, in the present embodiment, the cover glass 84 is provided such that it covers substantially the entire surface of the upper surface of the main body part 81, but the cover glass 84 may be provided such that it covers only the part of the upper surface of the main body part 81 that includes the grating RG. In addition, the protective member (i.e., the cover glass 84) may be formed from the same raw material as that of the main body part 81, but the present invention is not limited thereto; for example, the protective member may be formed from, for example, a metal or a ceramic material, or a configuration may be adopted wherein the protective member is formed as a thin film or the like.

As can be understood also from FIG. 4A, the main body part 81 is, as a whole, an octagonal plate shaped member wherein overhanging parts that protrude toward the outer side from both end parts in the longitudinal directions are formed, and a recessed part is formed in the bottom surface of the main body part 81 at the portion that opposes the grating RG The center area of the main body part 81 at which the grating RG is disposed is formed as a plate with a substantially uniform thickness.

As shown in FIG. 4A and FIG. 4B, the slider part 82a comprises two plate shaped members 82a₁, 82a₂, which are rectangular in a plan view and whose size in the Y axial directions (i.e., length) and size in the X axial directions (i.e., width) are both smaller (by about one half) than those of the stator part 93a. The plate shaped members 82a₁, 82a₂ are fixed to the +X side end part of the main body part 81 in the state wherein they are spaced apart from one another by a prescribed distance in the Z axial directions (i.e., the vertical directions) and such that they are parallel to the XY plane. The −X side end part of the stator part 93a is noncontactually inserted between the two plate shaped members 82a₁, 82a₂. The plate shaped members 82a₁, 82a₂ respectively house magnet units MUa₁, MUa₂ (discussed below).

The slider part 82b comprises two plate shaped members 82b₁, 82b₂, which are maintained at a prescribed spacing in the Z axial directions (i.e., the vertical directions), and is bilaterally symmetric with and configured identically to the slider part 82a. The +X side end part of the stator part 93b is inserted noncontactually between the two plate shaped members 82b₁, 82b₂. The plate shaped members 82b₁, 82b₂ respectively house magnet units MUb₁, MUb₂, which are respectively configured identically to the magnet units MUa₁, MUa₂.

Here, as discussed above, both side surfaces of the coarse motion stages WCS in the Y axial directions are open; therefore, when the fine motion stage WFS is mounted to the coarse motion stages WCS, the fine motion stage WFS should be positioned in the Z axial directions such that the stator parts 93a, 93b are positioned between the plate shaped members 82a₁, 82a₂ and 82b₁, 82b₂, respectively; subsequently, the fine motion stage WFS should be moved (i.e., slid) in the Y axial directions.

The fine motion stage drive system 52 comprises: the pair of magnet units MUa₁, MUa₂, which are provided by the slider part 82a (discussed above); the coil unit CUa, which is provided by the stator part 93a; the pair of magnet units MUb₁, MUb₂, which is provided by the slider part 82b (discussed above); and the coil unit CUb, which is provided by the stator part 93b.

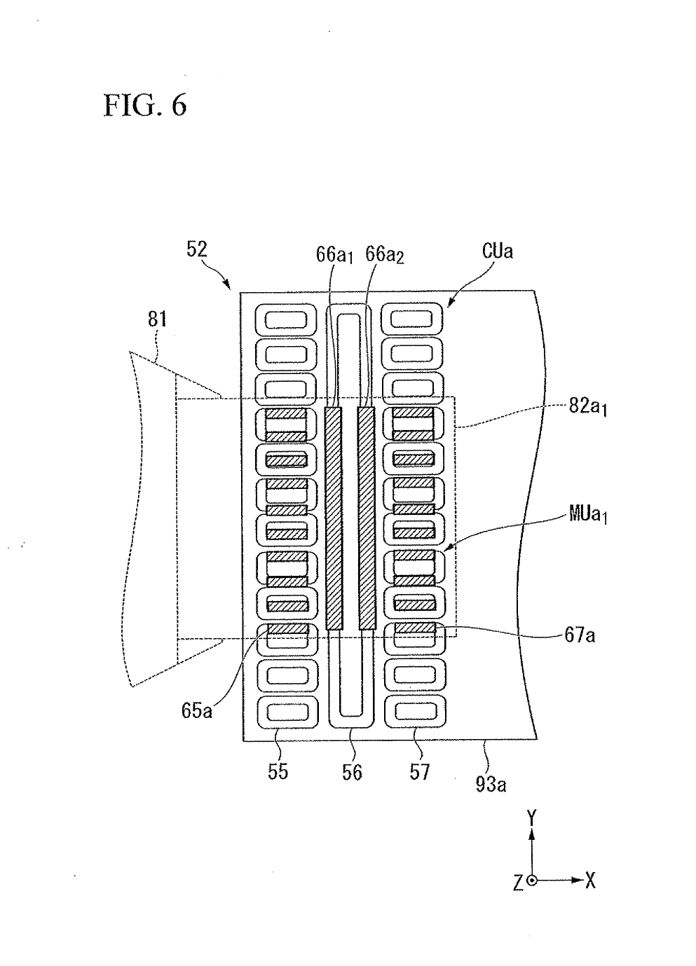

This will now be discussed in more detail. As can be understood from FIG. 6, a plurality of YZ coils 55, 57 (here, 12 each; hereinbelow, abbreviated as “coils” where appropriate), which are oblong in a plan view, are disposed equispaced in the Y axial directions inside the stator part 93a such that they constitute a two column coil array. The two columns of the coil array are disposed with a prescribed spacing between them in the X axial directions. Each of the YZ coils 55 comprises an upper part winding and a lower part winding (not shown), which are rectangular in a plan view and disposed such that they overlap in the vertical directions (i.e., the Z axial directions). In addition, one X coil 56 (hereinbelow, abbreviated as “coil” where appropriate), which in a plan view is a long, thin oblong whose longitudinal directions are oriented in the Y axial directions, is disposed inside the stator part 93a and between the columns of the two-column coil array discussed above. In this case, each of the columns of the two-column coil array and the X coil 56 are disposed equispaced in the X axial directions. Together, the two-column coil array and the X coil 56 constitute the coil unit CUa.

Furthermore, the following text explains the stator part 93a and the slider part 82a, which have the coil unit CUa and the magnet units MUa₁, MUa₂, respectively, referencing FIG. 6; the other stator and slider, that is, the stator part 93b and the slider part 82b, are similarly configured and function in the same manner.

As can be understood by referencing FIG. 6, a plurality of permanent magnets 65a, 67a (herein, 10 of each), which are oblong in a plan view and whose longitudinal directions are oriented in the X axial directions, are disposed equispaced in the Y axial directions inside the +Z side plate shaped member 82a₁, which constitutes part of the slider part 82a, and thereby constitute a two-column magnet array. The two columns of the magnet array are disposed spaced apart from one another by a prescribed spacing in the X axial directions and such that they oppose the coils 55, 57. In addition, two permanent magnets 66a₁, 66a₂, which are disposed spaced apart in the X axial directions and whose longitudinal directions are oriented in the Y axial directions, are disposed inside the plate shaped member 82a₁ between the columns of the two-column magnet array discussed above such that they oppose the coil 56.

The permanent magnets 65a are arrayed such that their directions of polarity alternate. The magnet column that comprises the plurality of the permanent magnets 67a is configured identically to the magnet column that comprises the plurality of the permanent magnets 65a. In addition, the permanent magnets 66a₁, 66a₂ are disposed such that their polarities are the opposite of one another. The plurality of the permanent magnets 65a, 67a and 66a₁, 66a₂ constitutes the magnet unit MUa₁.

As in the plate shaped member 82a₁ discussed above, permanent magnets also are disposed inside the plate shaped member 82a₂ on the −Z side, and these permanent magnets constitute the magnet unit MUa₂.

Here, the positional relationship in the Y axial directions between the permanent magnets 65a, which are disposed adjacently in the Y axial directions, and the YZ coils 55 (i.e., the relationship of the spacings between them) is set such that, when the two adjacent permanent magnets 65a (called “first and second permanent magnets” for the sake of convenience) oppose the winding parts of the YZ coils 55 (called “first YZ coils” for the sake of convenience), the third permanent magnet 65a adjacent to the second permanent magnet 65a does not oppose the winding part of the second YZ coil 55 adjacent to the first YZ coil 55 discussed above (i.e., the positional relationship is set either such that the third permanent magnet 65a opposes the hollow part at the center of the coil or such that it opposes the core, for example, the iron core, around which the coil is wound). In such a case, the fourth permanent magnet 65a, which is adjacent to the third permanent magnet 65a, and the fifth permanent magnet 65a each oppose the winding part of the third YZ coil 55, which is adjacent to the second YZ coil 55. This likewise applies to the spacing in the Y axial directions between the permanent magnets 67a and the two column permanent magnet array inside the plate shaped member 82a₂ on the −Z side.

Because the present embodiment adopts the arrangement of the coils and permanent magnets as discussed above, the main control apparatus 20 can drive the fine motion stage WFS in the Y axial directions by supplying an electric current to every other coil of the plurality of the YZ coils 55, 57 arrayed in the Y axial directions. In addition, in parallel therewith, the main control apparatus 20 can levitate the fine motion stage WFS above the coarse motion stages WCS through generating driving forces in the Z axial directions that are separate from the driving forces in the Y axial directions by supplying electric currents to coils of the YZ coils 55, 57 that are not used to drive the fine motion stage WFS in the Y axial directions. Furthermore, by sequentially switching, in accordance with the position of the fine motion stage WFS in the Y axial directions, which of the coils are supplied with electric current, the main control apparatus 20 drives the fine motion stage WFS in the Y axial directions while maintaining the state wherein the fine motion stage WFS is levitated above the coarse motion stages WCS, namely, a noncontactual state. In addition, in the state wherein the fine motion stage WFS is levitated above the coarse motion stages WCS, the main control apparatus 20 can also drive the fine motion stage WFS independently in the X axial directions in addition to the Y axial directions.

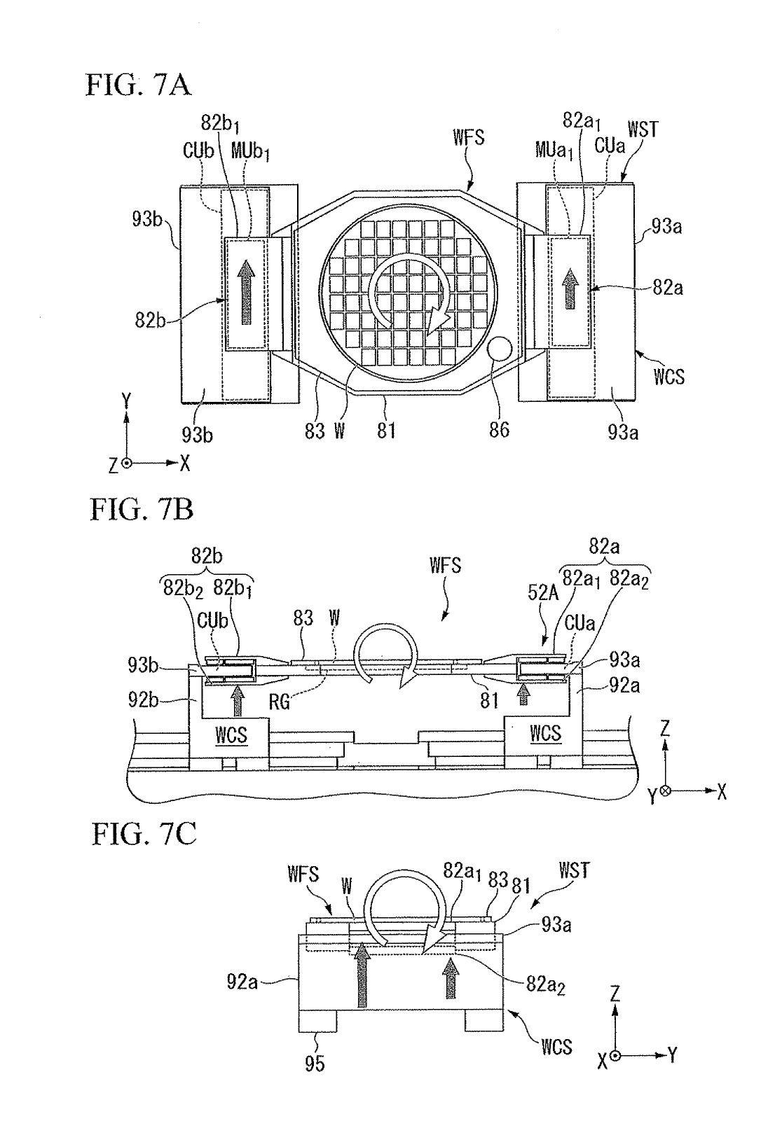

In addition, as shown in, for example, FIG. 7A, the main control apparatus 20 can rotate the fine motion stage WFS around the Z axis (i.e., can perform θz rotation; refer to the outlined arrow in FIG. 7A) by causing driving forces (i.e., thrusts) in the Y axial directions of differing magnitudes to act on the slider part 82a and the slider part 82b (refer to the solid arrows in FIG. 7A). Furthermore, the fine motion stage WFS can be rotated counterclockwise around the Z axis by, in a method the reverse of that described in FIG. 7A, making the driving force that acts on the slider part 82a on the +X side larger than the driving force that acts on the slider part 82a on the −X side.

In addition, as shown in FIG. 7B, the main control apparatus 20 can rotate the fine motion stage WFS around the Y axis (i.e., can perform θy drive (θy rotation); refer to the outlined arrow in FIG. 7B) by causing levitational forces of differing magnitudes to act on the slider part 82a and the slider part 82b (refer to the solid arrows in FIG. 7B). Furthermore, the fine motion stage WFS can be rotated counterclockwise around the Y axis by, in a method the reverse of that described in FIG. 7B, making the levitational forces that act on the slider part 82a greater than the levitational forces that act on the slider part 82b.

Furthermore, as shown in, for example, FIG. 7C, the main control apparatus 20 can rotate the fine motion stage WFS around the X axis (i.e., can perform θx drive (θx rotation); refer to the outlined arrow in FIG. 7C) by causing levitational forces of differing magnitudes to act on the +Y side and the −Y side slider parts 82a, 82b in the Y axial directions (refer to the solid arrows in FIG. 7C). Furthermore, the fine motion stage WFS can be rotated counterclockwise around the X axis by, in a method the reverse of that described in FIG. 7C, making the levitational force that acts on the side portion smaller than the levitational force that acts on the +Y side portion of the slider parts 82a (and 82b).

As is understood from the explanation above, in the present embodiment, the fine motion stage drive system 52 can levitationally support the fine motion stage WFS in a noncontactual state above the coarse motion stages WCS and can drive the coarse motion stages WCS noncontactually in directions corresponding to six degrees of freedom (i.e., in the X, Y, Z, θx, θy, and θz directions).

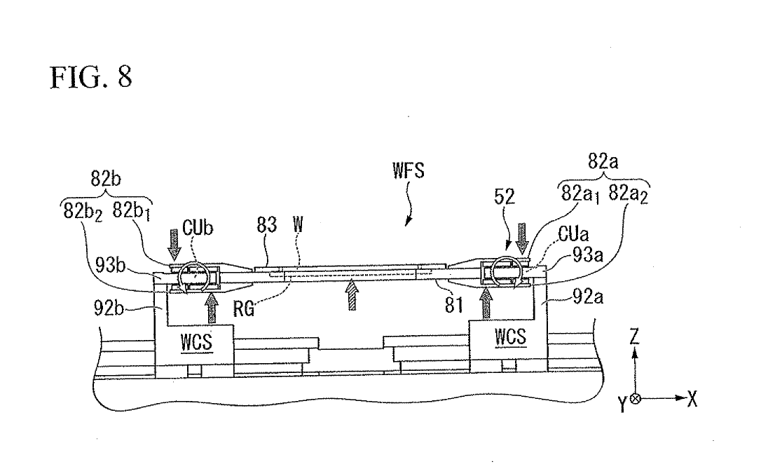

In addition, in the present embodiment, when levitational forces are caused to act on the fine motion stage WFS, the main control apparatus 20 can cause a rotational force around the Y axis to act on the slider part 82a (refer to the outlined arrow in FIG. 8) at the same time that levitational forces act on the slider part 82a (refer to the solid arrow in FIG. 8), as shown in, for example, FIG. 8, by supplying electric currents in opposite directions to the two columns of coils 55, 57 (refer to FIG. 6) disposed inside the stator part 93a. Similarly, when levitational forces are caused to act on the fine motion stage WFS, the main control apparatus 20 can cause a rotational force around the Y axis to act on the slider part 82b at the same time that levitational forces act on the slider part 82a by supplying electric currents in opposite directions to the two columns of coils 55, 57 disposed inside the stator part 93b.

In addition, the main control apparatus 20 can flex in the +Z direction or the direction (refer to the hatched arrow in FIG. 8) the center part of the fine motion stage WFS in the X axial directions by causing rotational forces around the Y axis (i.e., in the θy directions) to act on the slider parts 82a, 82b in opposite directions. Accordingly, as shown in FIG. 8, the main control apparatus 20 can ensure a degree of parallelism between the front surface of the wafer W and the XY plane (i.e., the horizontal plane) by flexing in the +Z direction (i.e., by causing to protrude) the center part of the fine motion stage WFS in the X axial directions and thereby canceling the flexure in the X axial directions of an intermediate portion of the fine motion stage WFS (i.e., the main body part 81) owing to the self weights of the wafer W and the main body part 81. Thereby, this aspect can be particularly effective when, for example, the size of the wafer W or of the fine motion stage WFS is increased.

In the exposure apparatus 100 of the present embodiment, when a step-and-scan type exposure operation is being performed on the wafer W, the main control apparatus 20 uses an encoder system 73 (refer to FIG. 5) of the fine motion stage position measuring system 70 (discussed below) to measure the position within the XY plane (including the position in the θz directions) of the fine motion stage WFS. The positional information of the fine motion stage WFS is sent to the main control apparatus 20, which, based thereon, controls the position of the fine motion stage WFS.

In contrast, when the wafer stage WST is outside of the measurement area of the fine motion stage position measuring system 70, the main control apparatus 20 uses the wafer stage position measuring system 16 (refer to FIG. 5) to measure the position of the wafer stage WST. As shown in FIG. 1, the wafer stage position measuring system 16 comprises laser interferometers, which radiate length measurement beams to reflective surfaces on the side surfaces of the coarse motion stages WCS, and measures the position within the XY plane (including the rotation in the θz directions) of the wafer stage WST. Furthermore, instead of using the wafer stage position measuring system 16 discussed above to measure the position within the XY plane of the wafer stage WST, some other measuring apparatus, for example, an encoder system, may be used.

As shown in FIG. 1, the fine motion stage position measuring system 70 comprises a measuring arm 71, which is inserted in the space inside each of the coarse motion stages WCS through an opening 18 (refer to FIG. 1 and FIG. 2) formed in the measurement stage MST in the state wherein the wafer stage WST is disposed below the projection optical system PL. The size of the opening 18 is such that the measurement stage MST can move in the X directions with a sufficient stroke even in the state wherein the measuring arm 71 is inserted through the opening 18.

The measuring arm 71 is supported in a cantilevered state by the main frame BD via a support part 72 (i.e., the vicinity of one-end part is supported).

The measuring arm 71 is a square columnar member (i.e., a rectangular parallelepipedic member) whose longitudinal directions are oriented in the Y axial directions and whose longitudinal oblong cross section is such that the size in the height directions (i.e., the Z axial directions) is greater than the size in the width directions (i.e., the X axial directions); furthermore, the measuring arm 71 is formed from the identical raw material wherethrough the light transmits, for example, by laminating together a plurality of glass members. The measuring arm 71 is formed as a solid, excepting the portion wherein the encoder head (i.e., the optical system) is housed (discussed below). As discussed above, a tip part of the measuring arm 71 is inserted in the spaces of the coarse motion stages WCS in the state wherein the wafer stage WST is disposed below the projection optical system PL; furthermore, as shown in FIG. 1, the upper surface of the measuring arm 71 opposes the lower surface of the fine motion stage WFS (more accurately, the lower surface of the main body part 81; not shown in FIG. 1; refer to FIG. 4A and the like). The upper surface of the measuring arm 71 is disposed substantially parallel to the lower surface of the fine motion stage WFS in the state wherein a prescribed clearance, for example, approximately several millimeters, is formed between the upper surface of the measuring arm 71 and the lower surface of the fine motion stage WFS.

As shown in FIG. 5, the fine motion stage position measuring system 70 comprises the encoder system 73 and the laser interferometer system 75. The encoder system 73 comprises an X linear encoder 73x, which measures the position of the fine motion stage WFS in the X axial directions, and a pair of Y linear encoders 73ya, 73yb, which measures the position of the fine motion stage WFS in the Y axial directions. The encoder system 73 uses diffraction interference type heads with a configuration identical to that of the encoder head (hereinbelow, abbreviated as “head” where appropriate) disclosed in, for example, U.S. Pat. No. 7,238,931 and U.S. Patent Application Publication No. 2007/288121. However, in the head of the present embodiment, the light source discussed above and a light receiving system (including a photodetector) are disposed outside of the measuring arm 71 (as discussed below), and only the optical system is disposed inside the measuring arm 71, namely, opposing the grating RG. Unless it is particularly necessary to use its proper name, the optical system disposed inside the measuring arm 71 is called a head.

The encoder system 73 uses one X head 77x (refer to FIG. 10A and FIG. 10B) to measure the position of the fine motion stage WFS in the X axial directions, and uses a pair of Y heads 77ya, 77yb (refer to FIG. 10B) to measure the position of the fine motion stage WFS in the Y axial directions. Namely, the X linear encoder 73x (discussed above) comprises the X head 77x that uses the X diffraction grating of the grating RG to measure the position of the fine motion stage WFS in the X axial directions, and the pair of Y linear encoders 73ya, 73yb comprises the pair of Y heads 77ya, 77yb that uses the Y diffraction grating of the grating RG to measure the position of the fine motion stage WFS in the Y axial directions.

Here, the configuration of the three heads 77x, 77ya, 77yb that constitute the encoder system 73 will be explained. FIG. 10A shows a schematic configuration of the X head 77x, which represents all three of the heads 77x, 77ya, 77yb. In addition, FIG. 10B shows the arrangement of the X head 77x and the Y heads 77ya, 77yb inside the measuring arm 71.

As shown in FIG. 10A, the X head 77x comprises a polarizing beam splitter PBS, a pair of reflective mirrors R1a, R1b, a pair of lenses L2a, L2b, a pair of quarter wave plates WP1a, WP1b (hereinbelow, denoted as λ/4 plates), a pair of reflective mirrors R2a, R2b, and a pair of reflective mirrors R1a, R3b; furthermore, these optical elements are disposed with prescribed positional relationships. The optical systems of the Y heads 77ya, 77yb also have the same configuration. As shown in FIG. 10A and FIG. 10B, the X head 77x and the Y heads 77ya, 77yb are each unitized and fixed inside the measuring arm 71.

As shown in FIG. 10B, in the X head 77x (i.e., the X encoder 73x), a light source LDx, which is provided to the upper surface of the −Y side end part of the measuring arm 71 (or there above), emits in the −Z direction a laser beam LBx₀, the laser beam LBx₀ transits a reflective surface RP, which is provided to part of the measuring arm 71 such that the reflective surface RP is tilted at a 45° angle with respect to the XY plane, and the optical path of the laser beam LBx₀ is thereby folded in a direction parallel to the Y axial directions. The laser beam LBx₀ advances parallel to the Y axial directions through the solid portion inside the measuring arm 71 and reaches the reflective mirror R3a (refer to FIG. 10A). Furthermore, the reflective mirror R3a folds the optical path of the laser beam LBx₀, and the laser beam LBx₀ thereby impinges the polarizing beam splitter PBS. The polarizing beam splitter PBS polarizes and splits the laser beam LBx₀, which becomes two measurement beams LBx₁, LBx₂. The measurement beam LBx₁, which transmits through the polarizing beam splitter PBS, reaches the grating RG, which is formed in the fine motion stage WFS, via the reflective mirror R1a; furthermore, the beam LBx₂, which is reflected by the polarizing beam splitter PBS, reaches the diffraction grating RG via the reflective mirror Rib. Furthermore, “polarization splitting” herein means the splitting of the incident beam into a P polarized light component and an S polarized light component.

Diffraction beams of a prescribed order (e.g., first order diffraction beams), which are generated by the grating RG as a result of the radiation of the beams LBx₁, LBx₂, transit the lenses L2a, L2b, are converted to circularly polarized beams by the λ/4 plates WP1a, WP1b, are subsequently reflected by the reflective mirrors R2a, R2b, pass once again through the λ/4 plates WP1a, WP1b, and reach the polarizing beam splitter PBS by tracing the same optical path as the forward path, only in reverse.

The polarization directions of each of the two first order diffraction beams that reach the polarizing beam splitter PBS are rotated by 90° with respect to the original directions. Consequently, the first order diffraction beams of the measurement beams LBx₁, LBx₂ are combined coaxially as a combined beam, LBx₁₂. The reflective mirror R3b folds the optical path of the combined beam LBx₁₂ such that it is parallel to the Y axis, after which the combined beam LBx₁₂ travels parallel to the Y axis inside the measuring arm 71, transits the reflective surface RP (discussed above), and is sent to an X light receiving system 74x, which is provided to the upper surface of the side end part of the measuring arm 71 (or there above), as shown in FIG. 10B.

In the X light receiving system 74x, the first order diffraction beams of the measurement beams LBx₁, LBx₂, which were combined into the combined beam LBx₁₂, are aligned in their polarization directions by a polarizer (i.e., an analyzer), which is not shown, and therefore interfere with one another to form an interfered beam, which is detected by the photodetector (not shown) and then converted to an electrical signal that corresponds to the intensity of the interfered beam. Here, when the fine motion stage WFS moves in either of the measurement directions (in this case, the X axial directions), the phase difference between the two beams changes, and thereby the intensity of the interfered beam changes. These changes in the intensity of the interfered beam are supplied to the main control apparatus 20 (refer to FIG. 5) as the positional information in the X axial directions of the fine motion stage WFS.

As shown in FIG. 10B, laser beams LBya₀, LByb₀, which are respectively emitted from light sources LDya, LDyb and whose optical paths are folded by 90° by the reflective surface RP (discussed above) such that the beams travel parallel to the Y axis, enter the Y heads 77ya, 77yb and, the same as discussed above, combined beams LBya₁₂, LByb₁₂ of the first order diffraction beams diffracted by the grating RG (i.e., the Y diffraction grating) from the measurement beams polarized and split by the polarizing beam splitters are output from the Y heads 77ya, 77yb, respectively, and then return to Y light receiving systems 74ya, 74yb. Here, the laser beams LBya₀, LByb₀, which were emitted from the light sources LDya, LDyb, and the combined beams LBya₁₂, LByb₁₂, which return to the Y light receiving systems 74ya, 74yb, travel with overlapping optical paths in the directions perpendicular to the paper plane in FIG. 10B. In addition, as discussed above, inside the Y heads 77ya, 77yb, the optical paths of the laser beams LBya₀, LByb₀ emitted from the light sources and the optical paths of the combined beams LBya₁₂, LByb₁₂ that return to the Y light receiving systems 74ya, 74yb are folded as appropriate (not shown) such that those optical paths are parallel and spaced apart in the Z axial directions.

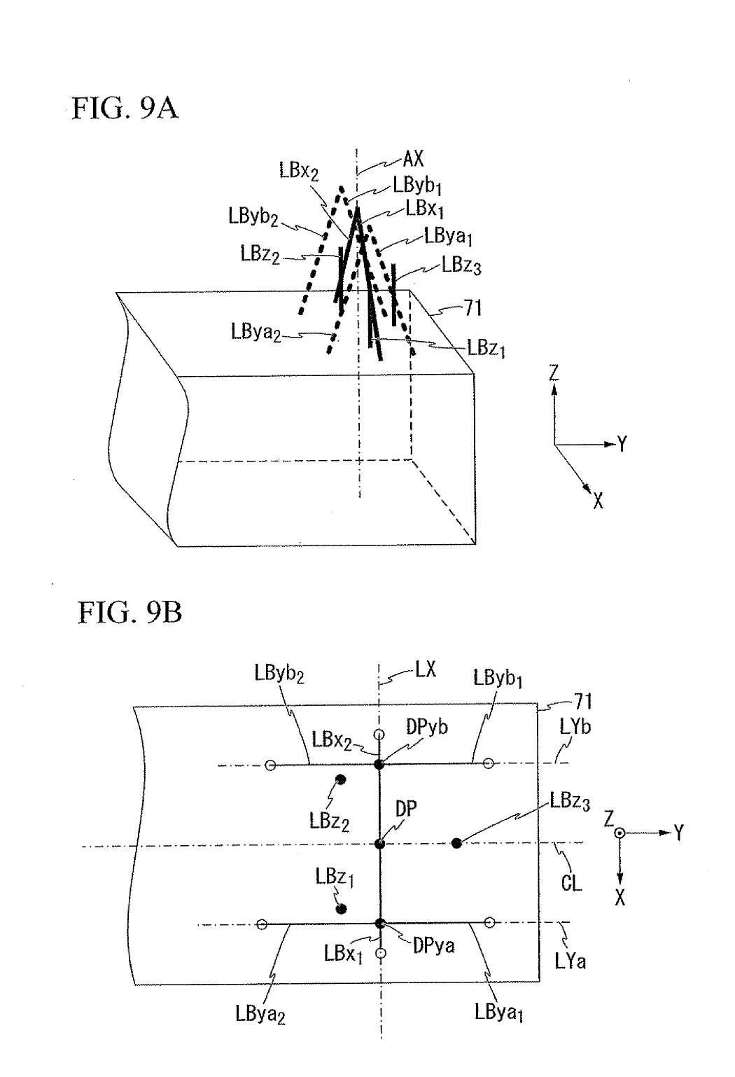

FIG. 9A is an oblique view of the tip part of the measuring arm 71, and FIG. 9B is a plan view, viewed from the +Z direction, of the upper surface of the tip part of the measuring arm 71. As shown in FIG. 9A and FIG. 9B, the X head 77x radiates the measurement beams LBx₁, LBx₂ (indicated by solid lines in FIG. 9A) from two points (refer to the white circles in FIG. 9B), which are equidistant from a centerline CL of the measuring arm 71 along a straight line LX parallel to the X axis, to the identical irradiation point on the grating RG (refer to FIG. 10A). The irradiation point of the measurement beams LBx₁, LBx₂, namely, the detection point of the X head 77x (refer to symbol DP in FIG. 9B) coincides with the exposure position (refer to FIG. 1), which is the center of the irradiation area IA (i.e., the exposure area) of the illumination light IL radiated to the wafer W. Furthermore, although the measurement beams LBx₁, LBx₂ are in actuality refracted by, for example, the interface surface between the main body part 81 and the air layer, this aspect is shown in a simplified form in FIG. 10A and the like.

As shown in FIG. 10B, the two Y heads 77ya, 77yb are disposed on opposite sides of the centerline CL, one on the +X side and one on the −X side. As shown in FIG. 9A and FIG. 9B, the Y head 77ya radiates measurement beams LBya₁, LBya₂, which are indicated by broken lines in FIG. 9A, from two points (refer to the white circles in FIG. 9B), which are equidistant from the straight line LX along a straight line LYa, to a common irradiation point on the grating RG. The irradiation point of the measurement beams LBya₁, LBya₂, namely, the detection point of the Y head 77ya, is indicated by a symbol DPya in FIG. 9B.

The Y head 77yb radiates measurement beams LByb₁, LByb₂ from two points (refer to the white circles in FIG. 9B), which are symmetric to the emitting points of the measurement beams LBya₁, LBya₂ of the Y head 77ya with respect to the centerline CL, to a common irradiation point DPyb on the grating RG.

As shown in FIG. 9B, the detection points DPya, DPyb of the Y heads 77ya, 77yb are disposed along the straight line LX, which is parallel to the X axis.

Here, the main control apparatus 20 determines the position of the fine motion stage WFS in the Y axial directions based on the average of the measurement values of the two Y heads 77ya, 77yb. Accordingly, in the present embodiment, the position of the fine motion stage WFS in the Y axial directions is measured such that the midpoint DP of the detection points DPya, DPyb serves as the effective measurement point. The midpoint DP coincides with the irradiation point of the measurement beams LBx₁, LBx₂ on the grating RG.

Namely, in the present embodiment, the positional measurements of the fine motion stage WFS in the X axial directions and the Y axial directions have a common detection point and this detection point coincides with the exposure position, which is the center of the irradiation area IA (i.e., the exposure area) of the illumination light IL radiated to the wafer W. Accordingly, in the present embodiment, the main control apparatus 20 can use the encoder system 73 to continuously measure—directly below the exposure position (i.e., on the rear surface side of the fine motion stage WFS)—the position of the fine motion stage WFS within the XY plane when the pattern of the reticle R is transferred to a prescribed shot region on the wafer W mounted on the fine motion stage WFS. In addition, the main control apparatus 20 measures the amount of rotation of the fine motion stage WFS in the θz directions based on the difference in the measurement values of the two Y heads 77ya, 77yb.

As shown in FIG. 9A, the laser interferometer system 75 causes three length measurement beams LBz₁, LBz₂, LBz₃ to emerge from the tip part of the measuring arm 71 and impinge the lower surface of the fine motion stage WFS. The laser interferometer system 75 comprises three laser interferometers 75a-75c (refer to FIG. 5), each of which radiates one of these three length measurement beams LBz₁, LBz₂, LBz₃.

As shown in FIG. 9A and FIG. 9B, in the laser interferometer system 75, the center of gravity of the three length measurement beams LBz₁, LBz₂, LBz₃ coincides with the exposure position, which is the center of the irradiation area IA (i.e., the exposure area), and the length measurement beams LBz₁, LBz₂, LBz₃ are emitted parallel to the Z axis from three points that correspond to the vertices of an isosceles triangle (or a regular triangle). In this case, the emitting point (i.e., the radiation point) of the length measurement beam LBz₃ is positioned along the centerline CL, and the emitting points (i.e., the radiation points) of the remaining length measurement beams LBz₁, LBz₂ are equidistant from the centerline CL. In the present embodiment, the main control apparatus 20 uses the laser interferometer system 75 to measure the position in the Z axial directions and the amounts of rotation in the θz and θy directions of the fine motion stage WFS. Furthermore, the laser interferometers 75a-75c are provided to the upper surface of the −Y side end part of the measuring arm 71 (or there above). The length measurement beams LBz₁, LBz₂, LBz₃, which are emitted in the −Z direction from the laser interferometers 75a-75c, transit the reflective surface RP (discussed above), travel along the Y axial directions inside the measuring arm 71, wherein their optical paths are folded, and emerge from the three points discussed above.

In the present embodiment, a wavelength selecting filter (not shown), which transmits the measurement beams from the encoder system 73 but hinders the transmission of the length measurement beams from the laser interferometer system 75, is provided to the lower surface of the fine motion stage WFS. In this case, the wavelength selecting filter serves double duty as the reflective surface of the length measurement beams from the laser interferometer system 75.

As can be understood from the explanation above, using the encoder system 73 of the fine motion stage position measuring system 70 and the laser interferometer system 75, the main control apparatus 20 can measure the position of the fine motion stage WFS in directions corresponding to six degrees of freedom. In this case, in the encoder system 73, the in-air optical path lengths of the measurement beams are extremely short and substantially equal, and consequently the effects of air turbulence are virtually inconsequential. Accordingly, the encoder system 73 can measure, with high accuracy, the position of the fine motion stage WFS within the XY plane (including the θz directions). In addition, because, within the XY plane, the effective detection point of the encoder system 73 on the grating RG in the X axial directions and in the Y axial directions and the detection point of the laser interferometer system 75 on the lower surface of the fine motion stage WFS in the Z axial directions coincide with the center (i.e., the exposure position) of the exposure area IA, so-called Abbé error owing to a shift between the detection point and the exposure position within the XY plane is suppressed to such a degree that it is substantially inconsequential. Accordingly, using the fine motion stage position measuring system 70, the main control apparatus 20 can measure, with high accuracy, the position of the fine motion stage WFS in the X axial directions, the Y axial directions, and the Z axial directions without Abbé error resulting from a shift between the detection point and the exposure position within the XY plane.

When a device is fabricated using the exposure apparatus 100 of the present embodiment, the pattern of the reticle R is transferred to each shot region of the plurality of shot regions on the wafer W by performing a step-and-scan type exposure on the wafer W, which is held by the fine motion stage held by the coarse motion stages WCS. In the step-and-scan type exposure operation, the main control apparatus 20 repetitively performs an inter-shot movement operation, wherein the fine motion stage WFS is moved to a scanning start position (i.e., an acceleration start position) in order to expose each of the shot regions on the wafer W, and a scanning exposure operation, wherein the pattern formed on the reticle R is transferred to each of the shot regions by a scanning exposure, based on for example, the result of the wafer alignment (e.g., the information obtained by converting the array coordinates of each shot region on the wafer W obtained by enhanced global alignment (EGA) to coordinates wherein the second fiducial mark serves as a reference) and the result of the reticle alignment, both alignments being performed in advance. Furthermore, the abovementioned exposure operation is performed in the state wherein the liquid Lq is held between the tip lens 191 and the wafer W, namely, the abovementioned exposure operation is performed by an immersion exposure. In addition, the operation is performed in order starting with the shot regions positioned on the +Y side and proceeding toward the shot regions positioned on the side. Furthermore, EGA is disclosed in detail in, for example, U.S. Pat. No. 4,780,617.

In the exposure apparatus 100 of the present embodiment, during the sequence of exposure operations discussed above, the main control apparatus 20 uses the fine motion stage position measuring system 70 to measure the position of the fine motion stage WFS (i.e., the wafer W) and, based on this measurement result, controls the position of the wafer W.

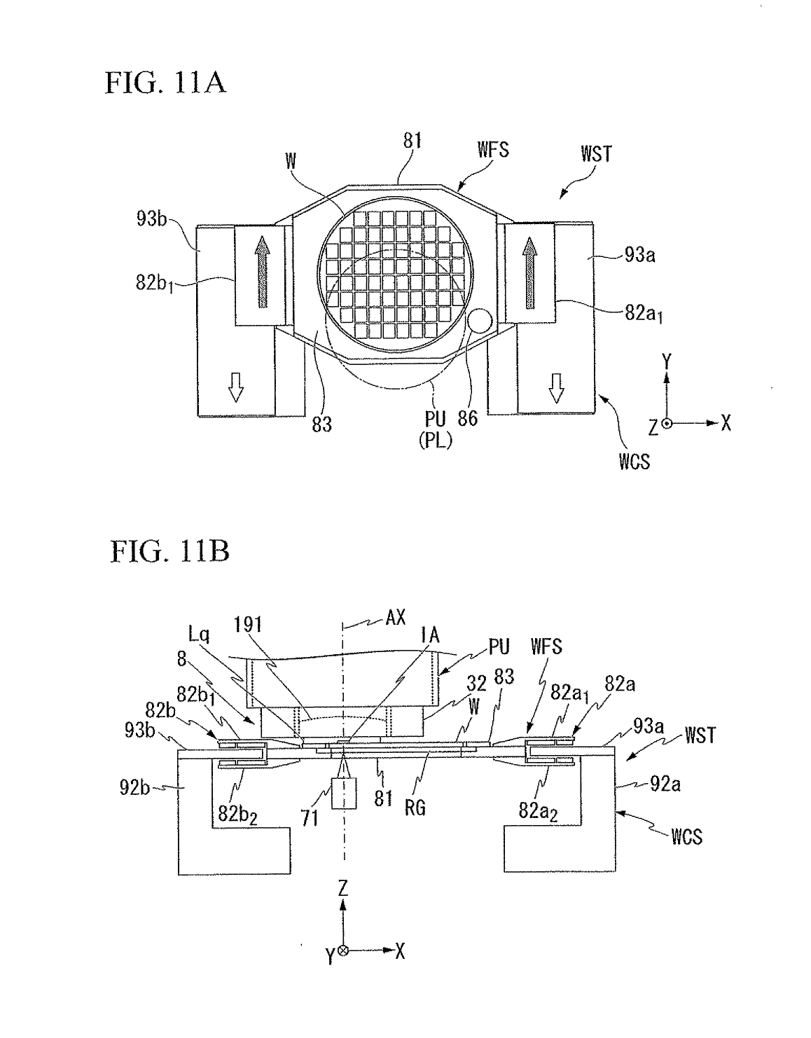

Furthermore, during the scanning exposure operation discussed above, the wafer W must be scanned in the Y axial directions at a high acceleration; however, in the exposure apparatus 100 of the present embodiment, as shown in FIG. 11A, the main control apparatus 20 scans the wafer W in the Y axial directions by driving only the fine motion stage WFS in the Y axial directions (refer to the solid arrows in FIG. 11A; and, as needed, in the directions corresponding to the other five degrees of freedom) without, as a rule, driving the coarse motion stages WCS. This is because to drive the wafer W at high acceleration, it is advantageous to drive the wafer W using only the fine motion stage WFS, which is lighter than the coarse motion stages WCS. In addition, as discussed above, the position measurement accuracy of the fine motion stage position measuring system 70 is higher than that of the wafer stage position measuring system 16, and therefore it is advantageous to drive the fine motion stage WFS during the scanning exposure. Furthermore, during the scanning exposure, the action of the reaction force (refer to the outlined arrows in FIG. 11A) generated by the drive of the fine motion stage WFS drives the coarse motion stages WCS in a direction opposite that of the fine motion stage WFS. Namely, the coarse motion stages WCS function as countermasses and conserve the momentum of the system that constitutes the entire wafer stage WST, and thereby the center of gravity does not move; therefore, the problem wherein, for example, a bias load acts on the base plate 12 owing to the drive of the fine motion stage WFS during a scan does not arise.

Moreover, when the inter-shot movement operation (i.e., stepping) is performed in the X axial directions, the fine motion stage WFS can move in the X axial directions by only a small amount; therefore, as shown in FIG. 11B, the main control apparatus 20 moves the wafer W in the X axial directions by driving the coarse motion stages WCS in the X axial directions.

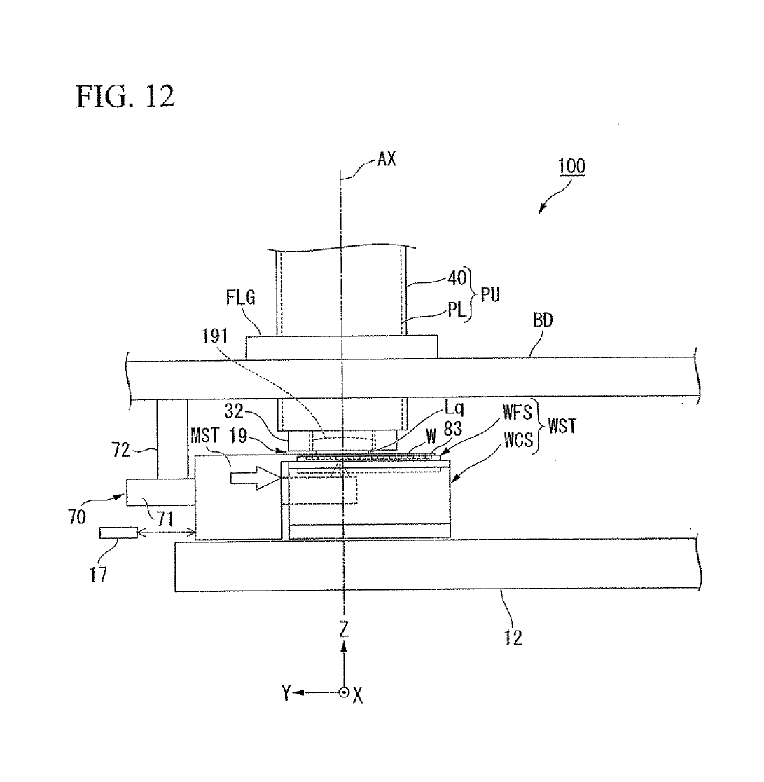

FIG. 12 shows a state (i.e., a first state) wherein, immediately after the exposure ends, an immersion space formed from the liquid Lq is held between the tip lens 191 and the wafer stage WST.

Prior to the end of the exposure, the main control apparatus 20 drives the measurement stage MST by a prescribed amount to the position shown in FIG. 1 via the measurement stage drive system 54 and, in this state, waits for the exposure to end.

Furthermore, when the exposure has ended, the main control apparatus 20 uses the measurement stage drive system 54 to drive the measurement stage MST by a prescribed amount in the +Y direction (refer to the outlined arrow in FIG. 12) and brings the measurement stage MST (i.e., the projection part 19 thereof) either into contact with the fine motion stage WFS or into close proximity therewith a clearance of approximately 300 μm. Namely, the main control apparatus 20 sets the measurement stage MST and the fine motion stage WFS to a “scrum” state.

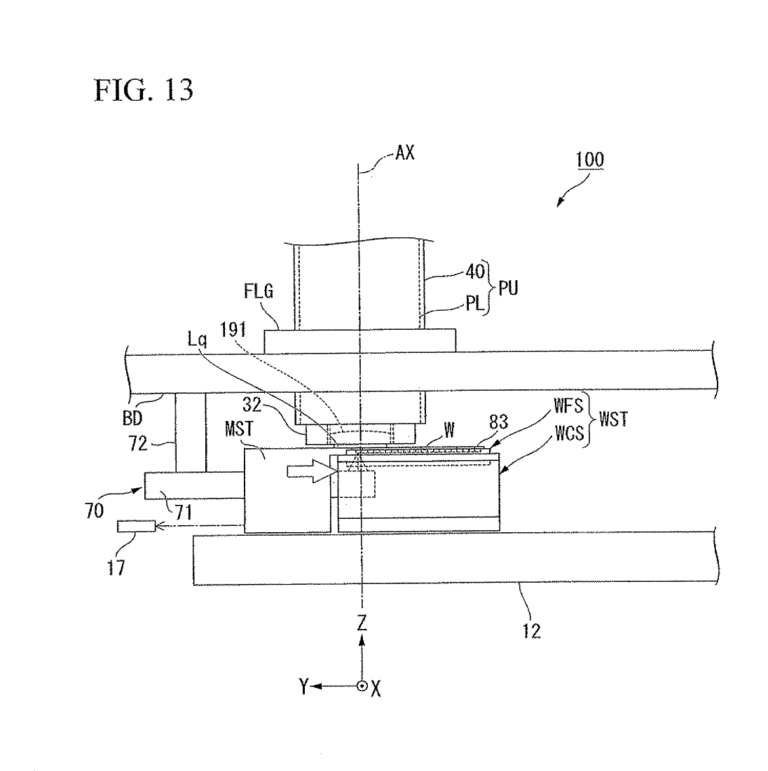

Next, as shown in FIG. 13, the main control apparatus 20 drives the measurement stage MST integrally with the wafer stage WST in the −Y direction (refer to the outlined arrow in FIG. 13) while maintaining the “scrum” state between the measurement stage MST and the fine motion stage WFS. Thereby, an immersion space, which is formed by the liquid Lq held between the fine motion stage WFS and the tip lens 191, is transferred from the fine motion stage WFS to the measurement stage MST. FIG. 13 shows the state immediately before the immersion space, which is formed from the liquid Lq, is transferred from the fine motion stage WFS to the measurement stage MST. In this state, the liquid Lq is held between the tip lens 191 on one side and the fine motion stage WFS and the measurement stage MST on the other side.

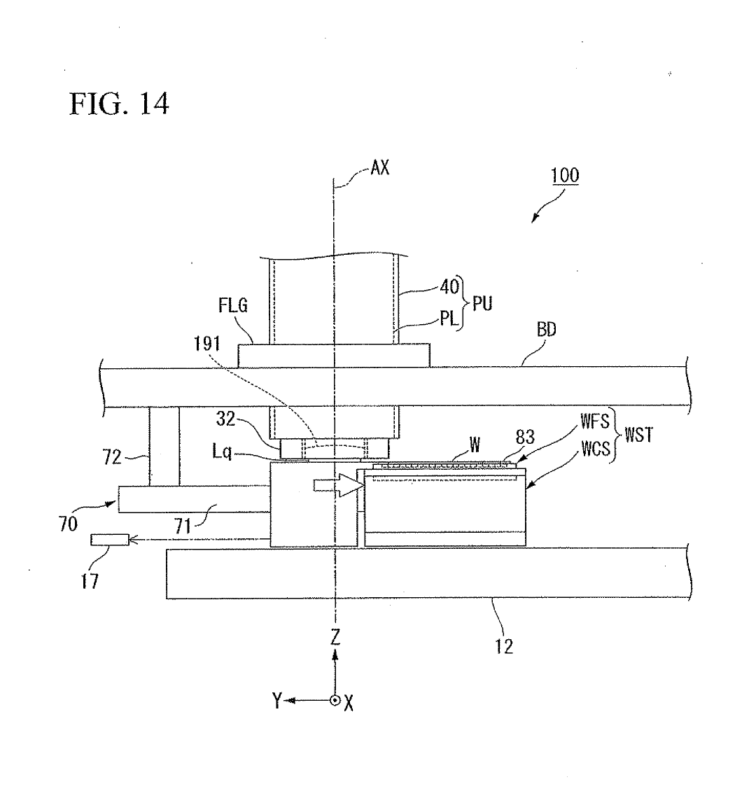

Furthermore, as shown in FIG. 14, when the transfer of the immersion space from the fine motion stage WFS to the measurement stage MST is complete and it transitions to a state (i.e., a second state) wherein the immersion space formed with the liquid Lq is held between the tip lens 191 and the measurement stage MST, the main control apparatus 20 moves the coarse motion stages WCS to a transfer position of the fine motion stage WFS (and the wafer W).

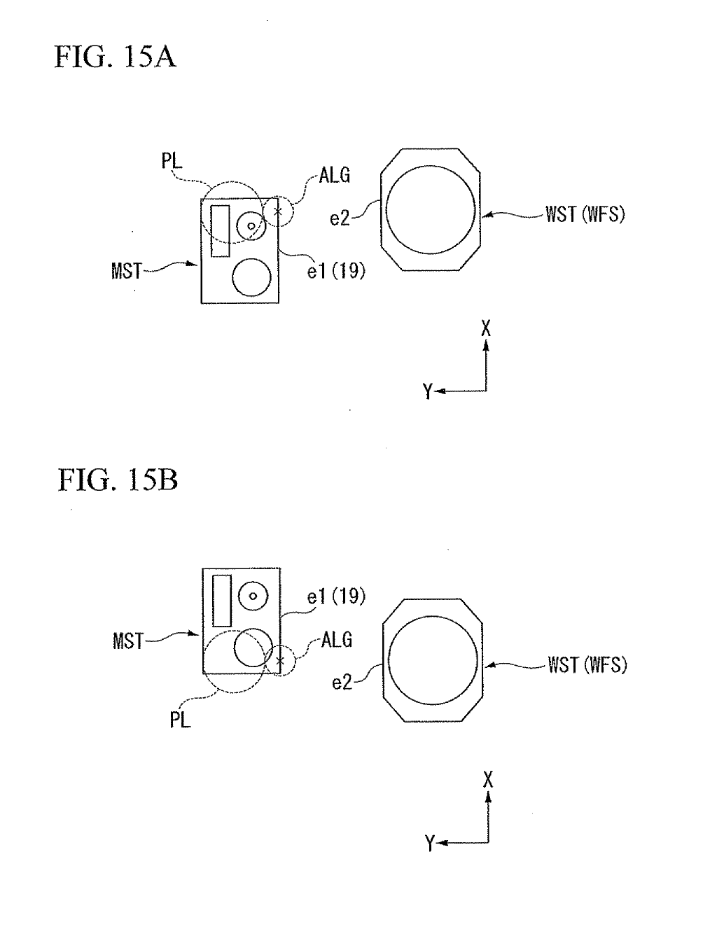

In the abovementioned transfer of the immersion space, if the clearance between the measurement stage MST (i.e., the projection part 19 thereof) and the fine motion stage WFS increases by a prescribed amount or greater or if the fine motion stage WFS or the measurement stage MST rotates around the Z axis, then maintaining the immersion space becomes difficult. Consequently, in the present embodiment, the wafer alignment system ALG and the multipoint focus position detection system AF are used to measure the relative position between the fine motion stage WFS and the measurement stage MST, for example, when the exposure apparatus 100 starts up, during periodic maintenance, or when a reset is performed that sets the exposure apparatus 100 to its initial state in the event of a power outage, an error, or the like. Furthermore, during the measurement of the relative position, the valves of both the liquid supply apparatus 5 and the liquid recovery apparatus 6 are in a closed state, and therefore the liquid Lq is not supplied to the space directly below the tip lens 191 of the projection optical system PL. Specifically, the main control apparatus 20 disposes the measurement stage MST below (i.e., in the −Z direction of) the projection optical system PL by the drive of the measurement stage drive system 54. At this time, as shown in FIG. 15A, the measurement stage MST is moved such that an edge part e1, which is on the −Y direction side of the measurement stage MST (i.e., the projection part 19) that opposes the fine motion stage WFS, enters a measurement field of the alignment system ALG. Next, the main control apparatus 20 moves the measurement stage MST in the −X direction by the drive of the X motors XM2 and disposes the measurement stage MST such that a +X direction end part (hereinbelow, called a measurement point P11) of the edge part e1 enters the measurement field of the alignment system ALG.

In this state, an image of the measurement point P11 is captured using the alignment system ALG. The captured image signal is supplied to the main control apparatus 20 and stored together with the position of the measurement stage MST at the time the image of the measurement point P11 was captured.

Next, the main control apparatus 20 moves the measurement stage MST in the +X direction by the drive of the X motors XM2 and disposes the measurement stage MST such that a −X direction end part (hereinbelow, called a measurement point P12) of the edge part e1 enters the measurement field of the alignment system ALG.

In this state, an image of the measurement point P12 is captured using the alignment system ALG. The captured image signal is supplied to the main control apparatus 20 and stored together with the position of the measurement stage MST at the time the image of the measurement point P12 was captured.

The main control apparatus 20 derives positional information about the measurement points P11, P12 within the measurement field by image processing each of the captured image signals of the measurement points P11, P12 obtained by the above process and, based on this positional information and on the position of the measurement stage MST detected at the time the image signals were captured, derives positional information about the measurement points P11, P12 in the Y directions.

Continuing, the main control apparatus 20 performs the same procedure on the fine motion stage WFS as that performed on the measurement stage MST; namely, the main control apparatus 20 disposes the fine motion stage WFS such that the +X direction end part (hereinbelow, called a measurement point P21) of a +Y direction side edge part e2 of the fine motion stage WFS that opposes the measurement stage MST enters the measurement field of the alignment system ALG, and uses the alignment system ALG to capture an image of the measurement point P21. The captured image signal is supplied to the main control apparatus 20 and stored together with the position of the fine motion stage WFS at the time the image of the measurement point P21 was captured.

Next, the main control apparatus 20 moves the fine motion stage WFS in the +X direction, disposes the fine motion stage WFS such that a −X direction end part (hereinbelow, called a measurement point P22) of the edge part e2 enters the measurement field of the alignment system ALG, and uses the alignment system ALG to capture an image of the measurement point P22. The captured image signal is supplied to the main control apparatus 20 and stored together with the position of the fine motion stage WFS at the time the image of the measurement point P22 was captured.

The main control apparatus 20 derives positional information about the measurement points P21, P22 within the measurement field by image processing each of the captured image signals of the measurement points P21, P22 that were obtained by the above process and, based on this positional information and on the position of the fine motion stage WFS detected at the time the image signals were captured, derives positional information about the measurement points P21, P22 in the Y directions.

The relative positional relationship between the edge part e1 and the edge part e2 in the Y directions, that is, the relative position between the measurement stage MST and the wafer stage WST in the Y directions, is derived based on positional information about the measurement points P11, P12 and positional information about the measurement points P21, P22 obtained from the above process. Because the edge part e1 is measured at the plurality of measurement points P11, P12 and the edge part e2 is measured at the plurality of measurement points P21, P22, it is also possible to derive the amount by which the edge part e1 and the edge part e2 deviate from being parallel as a result of the rotation of the wafer stage WST or the measurement stage MST around the Z axis. Furthermore, the main control apparatus 20 uses the information that indicates the relative position between the measurement stage MST and the fine motion stage WFS in the Y directions derived by the above process to control the drive of the measurement stage MST and the fine motion stage WFS during an exposure (and during the transfer of the immersion space); thus, by controlling the Y motors YM1, YM2, the main control apparatus 20 can control the clearance between the measurement stage MST and the fine motion stage WFS.

In addition, the relative position between the measurement stage MST and the fine motion stage WFS in the Z directions can be measured and adjusted using the multipoint AF system AF.

Specifically, the main control apparatus 20 drives the Y motors YM1, YM2 and disposes both the measurement stage MST and the fine motion stage WFS such that they are positioned below (i.e., in the −Z direction of) the projection optical system P1, in the state wherein the edge part e1 of the measurement stage MST and the edge part e2 the fine motion stage WFS are brought into close proximity with one another.

Furthermore, the positions of the wafer stage WST and the measurement stage MST in the Y directions are set such that the detection area of the multipoint AF system AF is set in the vicinity of the edge part e2 of the fine motion stage WFS. When the arrangement in the Y directions is complete, the main control apparatus 20 drives the X motors XM1 to move the fine motion stage WFS in the −X direction and disposes the fine motion stage WFS such that the detection area of the multipoint AF system AF is set in the vicinity of a +X direction end part (hereinbelow, called a measurement surface P31) of the edge part e2. In this state, the multipoint AF system AF is used to detect the measurement surface P31. The detection result is supplied to the main control apparatus 20.

Next, the main control apparatus 20 drives the X motors XM1 to move the fine motion stage WFS in the +X direction and disposes the fine motion stage WFS such that the detection area of the multipoint AF system AF is set in the vicinity of a −X direction end part (hereinbelow, called a measurement surface P32) of the edge part e2. In this state, the multipoint AF system AF is used to detect the measurement surface P32. The detection result is supplied to the main control apparatus 20. Next, the main control apparatus 20 drives the Y motors YM1, YM2 to move the wafer stage WST and the measurement stage MST in the −Y direction in the state wherein their relative positional relationship is maintained and sets the positions of the measurement stage MST and the fine motion stage WFS in the Y directions such that the detection area of the multipoint AF system AF is set in the vicinity of the edge part e1 of the measurement stage MST.

When the arrangement in the Y directions is complete, the main control apparatus 20 drives the X motors XM2 so as to move the measurement stage MST in the −X direction and disposes the measurement stage MST such that the detection area of the multipoint AF system AF is set in the vicinity of a −X direction end part (hereinbelow, called a measurement surface P41) of the edge part e1. In this state, the multipoint AF system AF is used to detect the measurement surface P41. The detection result is supplied to the main control apparatus 20.

Next, the main control apparatus 20 drives the X motors XM2 to move the measurement stage MST in the +X direction and disposes the measurement stage MST such that the detection area of the multipoint AF system AF is set in the vicinity of a −X direction end part (hereinbelow, called a measurement surface P42) of the edge part e1. In this state, the multipoint AF system AF is used to detect the measurement surface P42. The detection result is supplied to the main control apparatus 20.

Based on the detection results of the measurement surfaces P31, P32 and the detection results of the measurement surfaces P41, P42 obtained by the above process, the relative positional relationship between the measurement stage MST and the fine motion stage WFS in the Z directions is derived. Furthermore, the information that indicates the relative position between the measurement stage MST and the fine motion stage WFS in the Z directions derived by the above process is used to control the drive of the measurement stage MST and the fine motion stage WFS in the Z directions during an exposure (and during the transfer of the immersion space).

As explained above, the present embodiment causes a transition from the state wherein the liquid Lq is held between the wafer W on the fine motion stage WFS and the projection optical system PL (i.e., the tip lens 191) to the state wherein the liquid Lq is held between the measurement stage MST and the projection optical system PL (i.e., the tip lens 191), which makes it possible to maximize throughput while continuously maintaining the immersion space—even while the fine motion stage WFS is being moved to, for example, the loading position or the alignment position and being made to perform other processes. In addition, in the present embodiment, because the Y motors YM2, which share the stators 150 with the Y motors YM1, drive the measurement stage MST, which maintains the immersion space, it is possible to prevent the size and the cost of the apparatus from increasing in the event that a separate stator 150 is provided.

In addition, in the present embodiment, the relative position between both stages can be adjusted based on the measurement result of the relative position between the measurement stage MST and the fine motion stage WFS in the Z directions and the Y directions, which makes it possible to transfer the liquid—without any leakage or leftover liquid—when the liquid is transferred between the measurement stage MST and the fine motion stage WFS.

Furthermore, in the abovementioned embodiment, the wafer W is aligned while its position (i.e., the position of the fine motion stage WFS) is measured via the laser interferometer system (not shown), but the present invention is not limited thereto; for example, a second fine motion stage position measuring system, which includes a measuring arm that is identically configured to the measuring arm 71 of the fine motion stage position measuring system 70 discussed above, may be provided in the vicinity of the wafer alignment system ALG and used to measure the position of a fine motion stage within the XY plane during a wafer alignment.

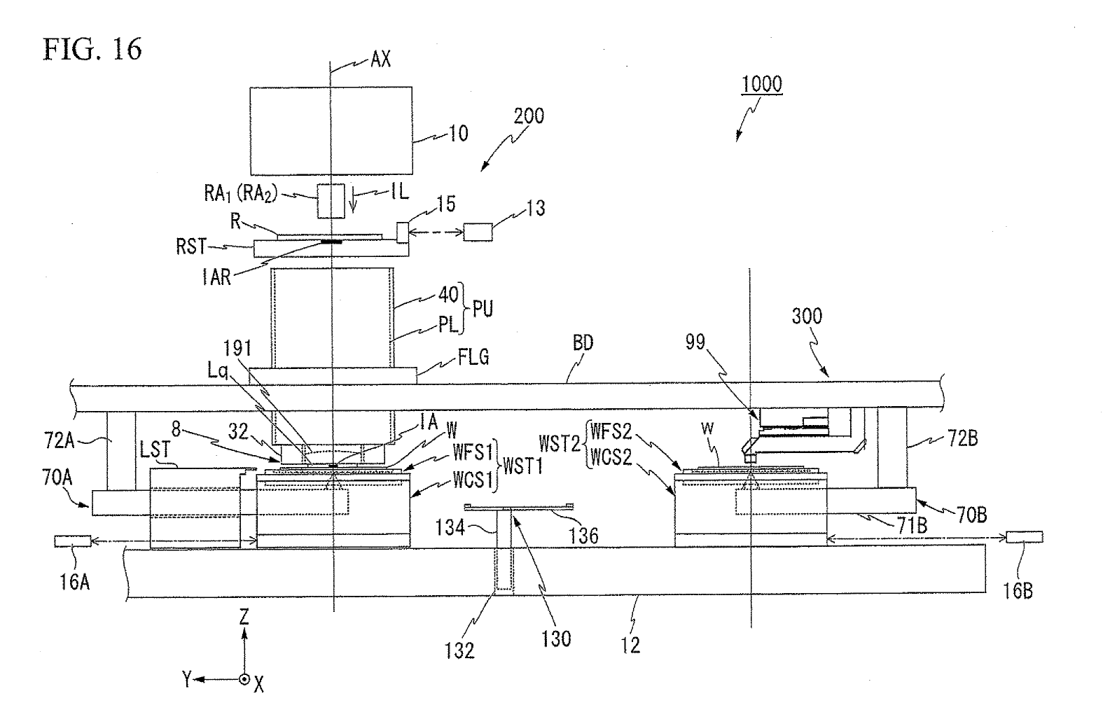

FIG. 16 through FIG. 18 show the configuration of an exposure apparatus 1000 according to a modified example that comprises the second fine motion stage position measuring system of the type described above. Furthermore, in the exposure apparatus 1000, a liquid holding stage LST is provided that serves not as a measurement stage but as an apparatus that holds the immersion space; furthermore, the liquid holding stage LST moves independently in only the Y directions by the drive of the Y motors YM2.

The exposure apparatus 1000 is a twin wafer stage type exposure apparatus that comprises an exposure station 200, wherein the projection unit PU is disposed, and a measurement station 300, wherein the alignment system ALG is disposed. Here, constituent parts that are identical or equivalent to the exposure apparatus 100 of the first embodiment discussed above are assigned identical or similar symbols, and explanations thereof are therefore abbreviated or omitted. In addition, if equivalent members are located at the exposure station 200 and the measurement station 300, then A and B are respectively appended to the symbols of these members to distinguish between them. However, the symbols for the two wafer stages are denoted WST1, WST2.

As can be understood by comparing FIG. 1 with FIG. 16, the exposure station 200 has basically the same configuration as the exposure apparatus 100 of the embodiment discussed above. In addition, a fine motion stage position measuring system 70B, which is disposed such that it is bilaterally symmetric with a fine motion stage position measuring system 70A on the exposure station 200 side, is disposed in the measurement station 300. In addition, in the measurement station 300, an alignment apparatus 99, instead of the alignment system ALG, is attached to and suspended from the body BD. A five-lens alignment system that comprises five FIA systems as disclosed in detail in, for example, PCT International Publication No. WO2008/056735 is used as the alignment apparatus 99.

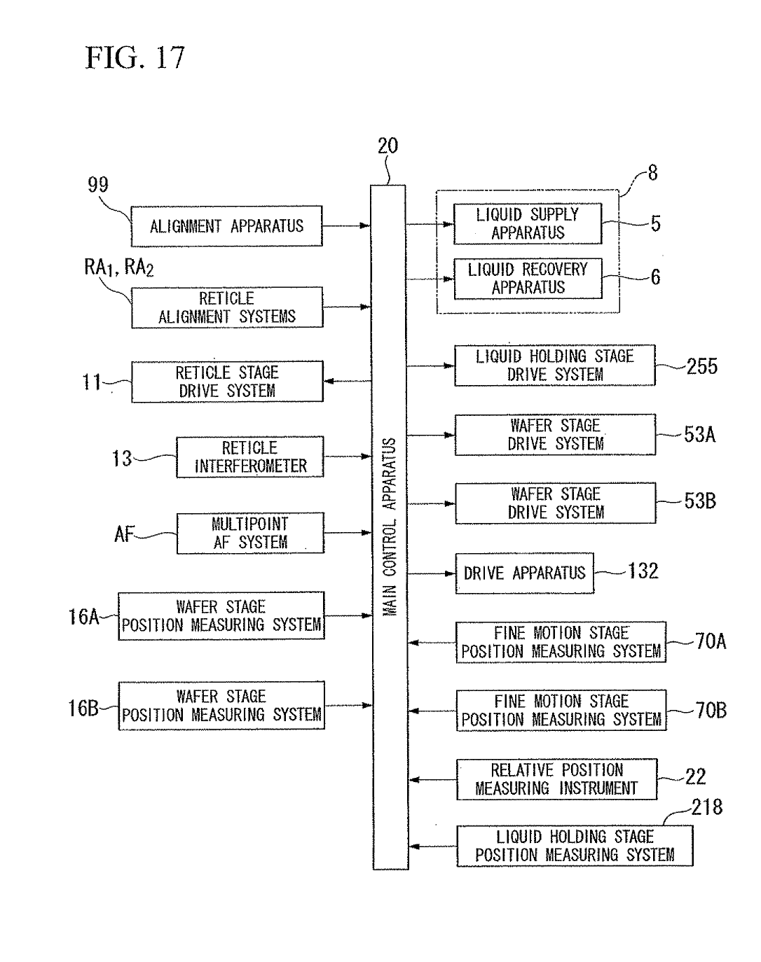

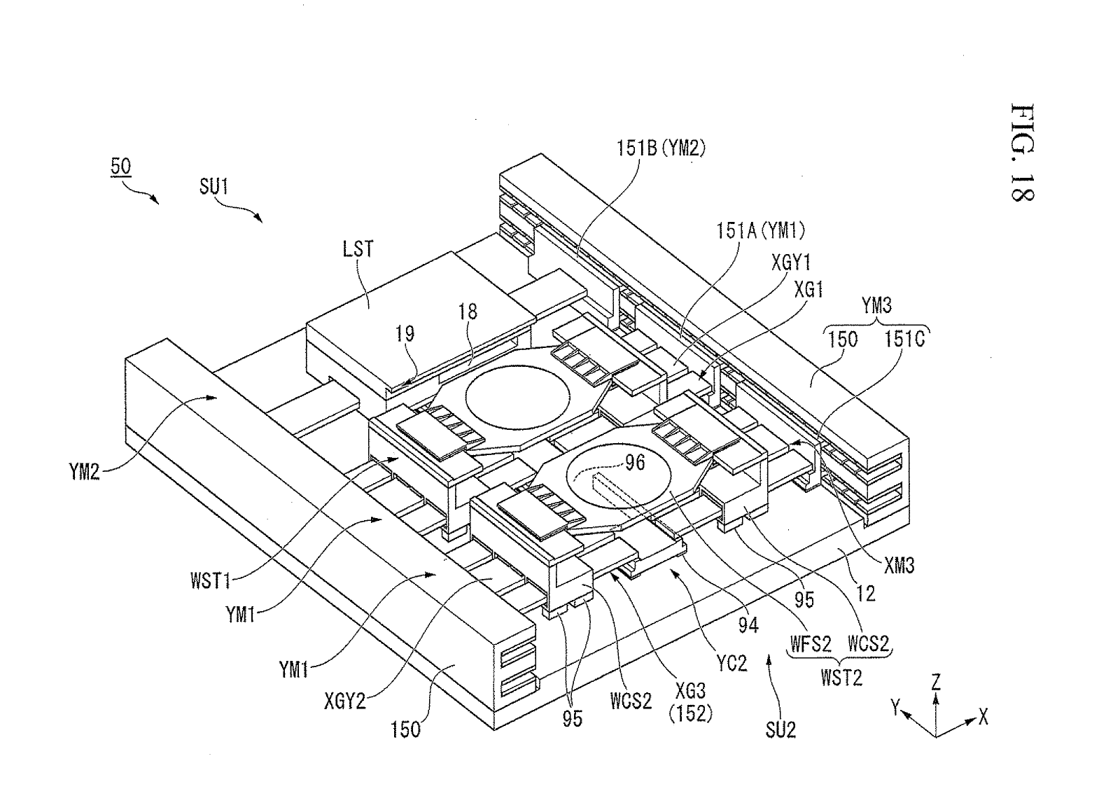

In addition, in the exposure apparatus 1000, a vertically moveable center table 130 is attached to the base plate 12 at a position between the exposure station 200 and the measurement station 300. The center table 130 comprises a shaft 134, which is capable of moving vertically by a drive apparatus 132 (refer to FIG. 17), and a table main body 136, which is fixed to an upper end of the shaft 134 and has a Y shape in a plan view. In addition, in each bottom surface of coarse motion stages WCS1, WCS2, which constitute the wafer stages WST1, WST2, respectively, a notch 96 is formed that is wider than the shaft 134, includes a separation line between a first portion and a second portion, and is, as a whole, U shaped. Thereby, the wafer stages WST1, WST2 are configured such that either can transport a fine motion stage WFS1 or WFS2 above the table main body 136.

The liquid holding stage LST is provided on the +Y side of the wafer stage WST1 and moves independently in the Y directions by the drive of the Y motors YM2. The liquid holding stage LST according to the present embodiment does not move in the X directions and is provided integrally with the sliders 151B. Furthermore, the liquid holding stage LST is configured identically to the measurement stage MST in that the opening 18 and the projection part 19 are both provided and the front surface is liquid repellent—the exceptions being that the various measuring instruments are not provided and the liquid holding stage LST does not move in the X directions.

FIG. 17 is a block diagram that shows the principal components of the control system of the exposure apparatus 1000.

In the exposure apparatus 1000 configured as discussed above, an exposure is performed in the exposure station 200 on the wafer W that is disposed on the fine motion stage WFS1 supported by the coarse motion stages WCS1 that constitute the wafer stage WST1, and, in parallel therewith, a wafer alignment (e.g., an EGA) or the like is performed in the measurement station 300 on the wafer W that is disposed on the fine motion stage WFS2 supported by the coarse motion stages WCS2 that constitute the wafer stage WST2.

Furthermore, when the exposure has ended, the wafer stage WST1 transports the fine motion stage WFS1, which holds the exposed wafer W, to above the table main body 136. During this movement of the wafer stage WST1, the liquid holding stage LST and the fine motion stage WFS1 are set to the “scrum” state by driving the liquid holding stage LST in the −Y direction by a prescribed amount to bring the liquid holding stage LST (and the projection part 19 thereof) into contact with the fine motion stage WFS1 or close proximity therewith a clearance of approximately 300 μm.

Furthermore, the liquid holding stage LST is driven in the −Y direction integrally with the wafer stage WST1 while maintaining this “scrum” state. Thereby, an immersion space, which is formed by the liquid Lq held between the fine motion stage WFS1 and the tip lens 191, is transferred from the fine motion stage WFS1 to the liquid holding stage LST.

When the wafer stage WST1 reaches the center table 130, the center table 130 is driven and lifted upward by the drive apparatus 132, and the main control apparatus 20 controls a wafer stage drive system 53A to move the two coarse motion stages WCS1 along the X guides XG1 in directions such that they move away from one another. Thereby, the fine motion stage WFS1 is transferred from the coarse motion stages WCS1 to the table main body 136. Furthermore, after the drive apparatus 132 lowers the center table 130, the two coarse motion stages WCS1 move in directions such that they approach one another. Furthermore, the wafer stage WST2 comes into close proximity or contact with the coarse motion stages WCS1 from the −Y direction, and the fine motion stage WFS2, which holds the aligned wafer W, is transferred from the coarse motion stages WCS2 to the coarse motion stages WCS1. The main control apparatus 20 performs this sequence of operations by controlling a wafer stage drive system 53B.

Subsequently, the coarse motion stages WCS1, which hold the fine motion stage WFS2, move to the exposure station 200 whereupon a reticle alignment is performed; furthermore, a step-and-scan type exposure operation is performed based on the result of that reticle alignment as well as the result of the wafer alignment (i.e., the array coordinates of each of the shot regions on the wafer W wherein the second fiducial mark serves as a reference).

When the coarse motion stages WCS1 are moved to the exposure station 200, the liquid holding stage LST and the fine motion stage WFS1 are set to the “scrum” state by bringing the liquid holding stage LST and the fine motion stage WFS1 into contact with one another or into close proximity with a clearance of approximately 300 μm. Furthermore, the liquid holding stage LST is driven integrally with the wafer stage WST1 in the +Y direction while maintaining this “serum” state. Thereby, an immersion space, which is formed by the liquid Lq held between the liquid holding stage LST and the tip lens 191, is once again transferred from the liquid holding stage LST to the fine motion stage WFS1.

In parallel with this exposure, the coarse motion stages WCS2 withdraw in the −Y direction, a transport system (not shown) transports the fine motion stage WFS1, which is held on the table main body 136, to a prescribed position, and a wafer exchange mechanism (not shown) exchanges the exposed wafer W held by the fine motion stage WFS1 for a new wafer W. Furthermore, the transport system transports the fine motion stage WFS1 that holds the new wafer W onto the table main body 136, after which the fine motion stage WFS1 is transferred from the table main body 136 onto the coarse motion stages WCS2. Subsequently, the same process described above is performed repetitively.

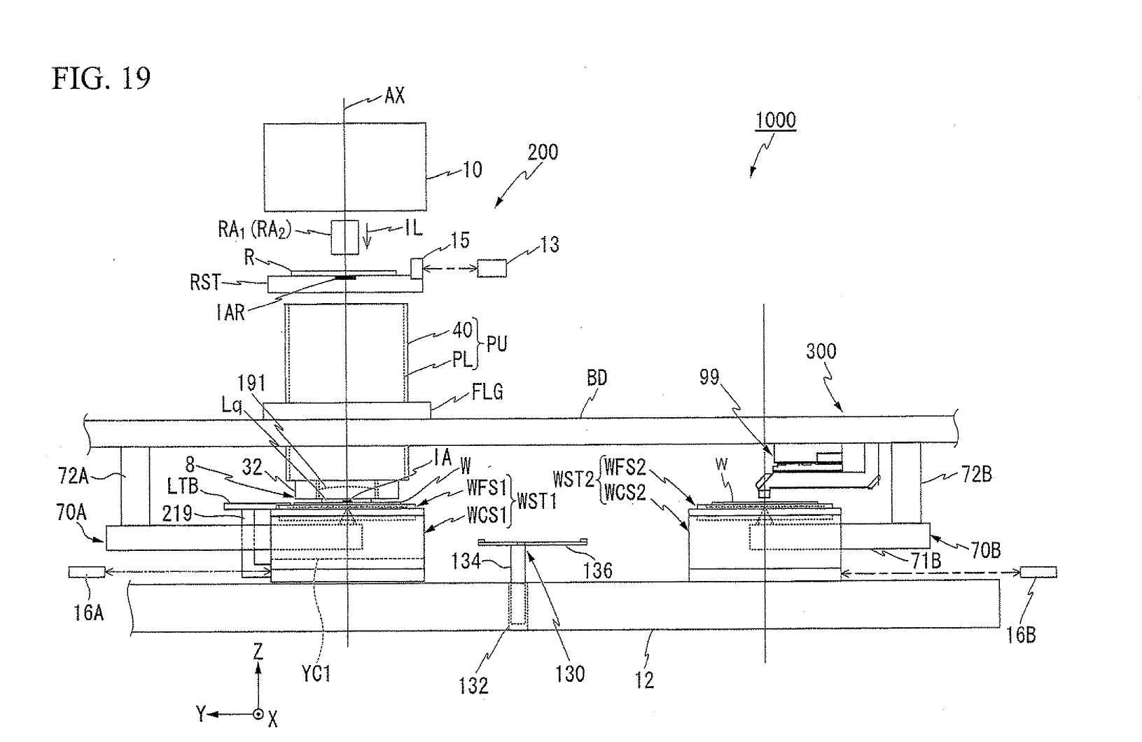

In addition, a configuration may be adopted wherein, in addition to the measurement stage MST, the liquid holding stage LST, and the like discussed above, a liquid holding table LTB, which is provided integrally with the Y coarse motion stage YC1 via a support part 219 as shown in FIG. 19, is used as the liquid holding member. In this case, the liquid holding table LTB is disposed on the +Y side of the fine motion stage WFS1 with the clearance discussed above and moves integrally with the wafer stage WST1 by the drive of the Y motors YM1. In other words, the liquid holding table LTB shares the Y motors YM1 with the wafer stage WST1 and moves in the Y directions.

Furthermore, the abovementioned embodiment and modified example explained an exemplary case wherein the fine motion stage WFS is supported moveably with respect to the coarse motion stages WCS and a sandwich structure that sandwiches from above and below a coil unit between a pair of magnet units is used for the first and second drive parts that drive the fine motion stage WFS in directions corresponding to six degrees of freedom. However, the present invention is not limited thereto; for example, the first and second drive parts may have a structure that sandwiches from above and below a magnet unit between a pair of coil units, or they may not have a sandwich structure. In addition, coil units may be disposed in the fine motion stage and magnet units may be disposed in the coarse motion stages.

In addition, in the abovementioned embodiment and modified example, the first and second drive parts drive the fine motion stage WFS in directions corresponding to six degrees of freedom, but the fine motion stage does not necessarily have to be able to be driven in six degrees of freedom. For example, the first and second drive parts do not have to be able to drive the fine motion stage in the θx directions.

Furthermore, in the abovementioned embodiment, the coarse motion stages WCS support the fine motion stage WFS noncontactually by virtue of the action of the Lorentz's forces (i.e., electromagnetic forces), but the present invention is not limited thereto; for example, a vacuum boosted aerostatic bearing and the like may be provided to the fine motion stage WFS, and the coarse motion stages WCS may levitationally support the fine motion stage WFS. In addition, the fine motion stage drive system 52 is not limited to the moving magnet type discussed above and may be a moving coil type. Furthermore, the coarse motion stages WCS may support the fine motion stage WFS contactually. Accordingly, the fine motion stage drive system 52 that drives the fine motion stage WFS with respect to the coarse motion stages WCS may comprise a combination of, for example, a rotary motor and a ball screw (or a feed screw).

In addition, the abovementioned embodiment and modified example explain a case wherein the fine motion stage position measuring system 70 comprises the measuring arm 71, which is formed entirely from, for example, glass, wherethrough light can travel, but the present invention is not limited thereto; for example, the measuring arm may be configured such that at least the portion wherethrough the laser beams discussed above can travel is formed as a solid member capable of transmitting the light, and the remaining portion is a member that, for example, does not transmit the light; furthermore, the measuring arm may have a hollow structure.

In addition, for example, the measuring arm 71 may be configured such that the light source, the photodetector, and the like are built into the tip part of the measuring arm 71 as long as the measurement beams can be radiated from the portion that opposes the grating RG. In such a case, the measurement beams of the encoder would not have to travel through the interior of the measuring arm. Furthermore, the shape of the measuring arm does not particularly matter. In addition, the fine motion stage position measuring system does not necessarily have to comprise the measuring arm and may have some other configuration as long as it comprises a head disposed such that it opposes the grating RG disposed in the spaces of the coarse motion stages WCS, radiates at least one measurement beam to the grating RG, and receives a diffracted beam of the measurement beam from the grating RG, and as long as the position of the fine motion stage WFS can be measured at least within the XY plane based on the output of that head.

In addition, the abovementioned embodiment explained an exemplary case wherein the encoder system 73 comprises the X head 77x and the pair of Y heads 77ya, 77yb, but the present invention is not limited thereto; for example, one or two two-dimensional heads (i.e., 2D heads), whose measurement directions are in two directions, namely, the X axial directions and the Y axial directions, may be provided. If two 2D heads are provided, then their detection points may be two points that are equidistantly spaced apart from the center of the exposure position on the grating RG in the X axial directions.

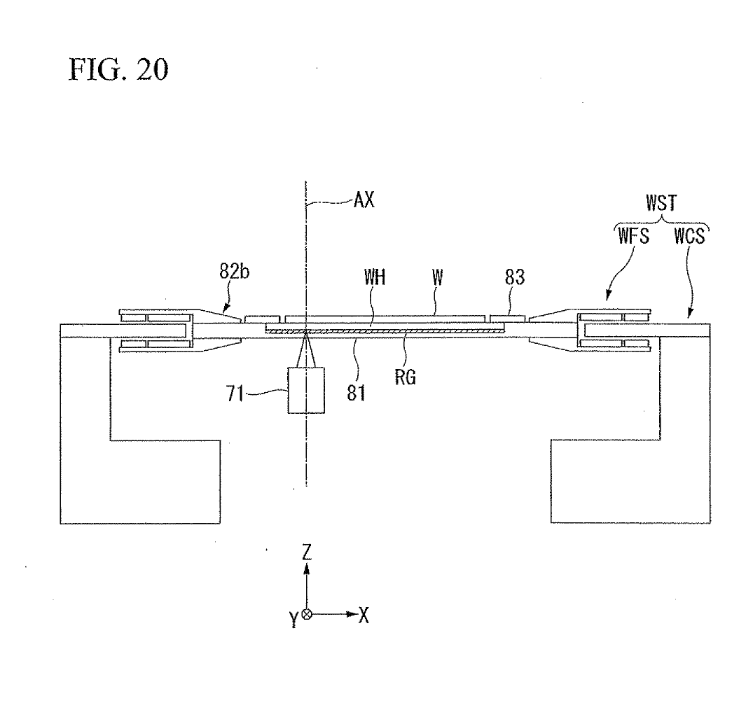

Furthermore, in the abovementioned embodiment, the grating RG is disposed on the upper surface of the fine motion stage WFS, namely, on the surface that opposes the wafer W, but the present invention is not limited thereto; for example, as shown in FIG. 20, the grating RG may be formed in the lower surface of a wafer holder WH, which holds the wafer W. In such a case, even if the wafer holder WH expands during an exposure or if a mounting position deviates with respect to the fine motion stage WFS, it is possible to track this deviation and still measure the position of the wafer holder WH (i.e., the wafer W). In addition, the grating may be disposed on the lower surface of the fine motion stage; in such a case, the measurement beams radiated from the encoder heads would not travel through the interior of the fine motion stage and, therefore, the fine motion stage would not have to be a solid member wherethrough the light can transmit, the interior of the fine motion stage could have a hollow structure wherein piping, wiring, and the like could be disposed, and thereby the fine motion stage could be made more lightweight.

Furthermore, the abovementioned embodiment explained a case wherein the exposure apparatus 100 is a liquid immersion type exposure apparatus, but the present invention is not limited thereto; for example, the present invention can be suitably adapted also to a dry type exposure apparatus that exposes the wafer W without transiting any liquid (i.e., water).

Furthermore, the abovementioned embodiment explained a case wherein the present invention is adapted to a scanning stepper, but the present invention is not limited thereto; for example, the present invention may also be adapted to a static type exposure apparatus, such as a stepper. Unlike the case wherein encoders measure the position of a stage whereon an object to be exposed is mounted and the position of the stage is measured using an interferometer, it is possible, even in the case of a stepper and the like, to reduce the generation of position measurement errors owing to air turbulence to virtually zero, and therefore to position the stage with high accuracy based on the measurement values of the encoder; as a result, a reticle pattern can be transferred with high accuracy to an object. In addition, the present invention can also be adapted to a step-and-stitch type reduction projection exposure apparatus that stitches shot regions together.

In addition, the projection optical system PL in the exposure apparatus 100 of the embodiment mentioned above is not limited to a reduction system and may be a unity magnification system or an enlargement system; furthermore, the projection optical system PL is not limited to a dioptric system and may be a catoptric system or a catadioptric system; in addition, the image projected thereby may be either an inverted image or an erect image.

In addition, the illumination light IL is not limited to ArF excimer laser light (with a wavelength of 193 nm), but may be ultraviolet light, such as KrF excimer laser light (with a wavelength of 248 nm), or vacuum ultraviolet light, such as F₂ laser light (with a wavelength of 157 nm). For example, as disclosed in U.S. Pat. No. 7,023,610, higher harmonics may also be used as the vacuum ultraviolet light by utilizing, for example, an erbium (or erbium-ytterbium) doped fiber amplifier to amplify single wavelength laser light in the infrared region or the visible region that is generated from a DFB semiconductor laser or a fiber laser, and then using a nonlinear optical crystal for wavelength conversion to convert the output laser light to ultraviolet light.

In addition, the illumination light IL of the exposure apparatus 100 in the abovementioned embodiment is not limited to light with a wavelength of 100 nm or greater, and, of course, light with a wavelength of less than 100 nm may be used. For example, the present invention can be adapted to an EUV exposure apparatus that uses extreme ultraviolet (EUV) light in the soft X-ray region (e.g., light in a wavelength band of 5-15 nm). In addition, the present invention can also be adapted to an exposure apparatus that uses a charged particle beam, such as an electron beam or an ion beam.

In addition, in the embodiment discussed above an optically transmissive mask (i.e., a reticle) wherein a prescribed shielding pattern (or a phase pattern or dimming pattern) is formed on an optically transmissive substrate is used; however, instead of such a reticle, an electronic mask—including variable shaped masks, active masks, and digital micromirror devices (DMDs), which are also called image generators and are one type of non-light emitting image display devices (i.e., spatial light modulators)—may be used wherein a transmissive pattern, a reflective pattern, or a light emitting pattern is formed based on electronic data of the pattern to be exposed, as disclosed in, for example, U.S. Pat. No. 6,778,257. In the case wherein a variable shaped mask is used, the stage whereon the wafer, a glass plate, or the like is mounted is scanned with respect to the variable shaped mask, and therefore effects equivalent to those of the above-mentioned embodiment can be obtained by using the encoder system and a laser interferometer system to measure the position of the stage.

In addition, by forming interference fringes on the wafer W as disclosed in, for example, PCT International Publication No. WO2001/035168, the present invention can also be adapted to an exposure apparatus (i.e., a lithographic system) that forms a line-and-space pattern on the wafer W.

Furthermore, the present invention can also be adapted to, for example, an exposure apparatus that combines the patterns of two reticles onto a wafer via a projection optical system and double exposes, substantially simultaneously, a single shot region on the wafer using a single scanning exposure, as disclosed in, for example, U.S. Pat. No. 6,611,316.

Furthermore, in the abovementioned embodiment, the object whereon the pattern is to be formed (i.e., the object to be exposed by being irradiated with an energy beam) is not limited to a wafer, and may be a glass plate, a ceramic substrate, a film member, or some other object such as a mask blank.

The application of the exposure apparatus 100 is not limited to an exposure apparatus for fabricating semiconductor devices, but can be widely adapted to, for example, an exposure apparatus for fabricating liquid crystal devices, wherein a liquid crystal display device pattern is transferred to a rectangular glass plate, as well as to exposure apparatuses for fabricating organic electroluminescent displays, thin film magnetic heads, image capturing devices (e.g., CCDs), micromachines, and DNA chips. In addition to fabricating microdevices like semiconductor devices, the present invention can also be adapted to an exposure apparatus that transfers a circuit pattern to a glass substrate, a silicon wafer, or the like in order to fabricate a reticle or a mask used by a light exposure apparatus, an EUV exposure apparatus, an X-ray exposure apparatus, an electron beam exposure apparatus, and the like.

Furthermore, the moving body apparatus of the present invention is not limited in its application to the exposure apparatus and can be widely adapted to any of the substrate processing apparatuses (e.g., a laser repair apparatus, a substrate inspecting apparatus, and the like) or to an apparatus that comprises a movable stage such as a sample positioning apparatus in a precision machine, or a wire bonding apparatus.

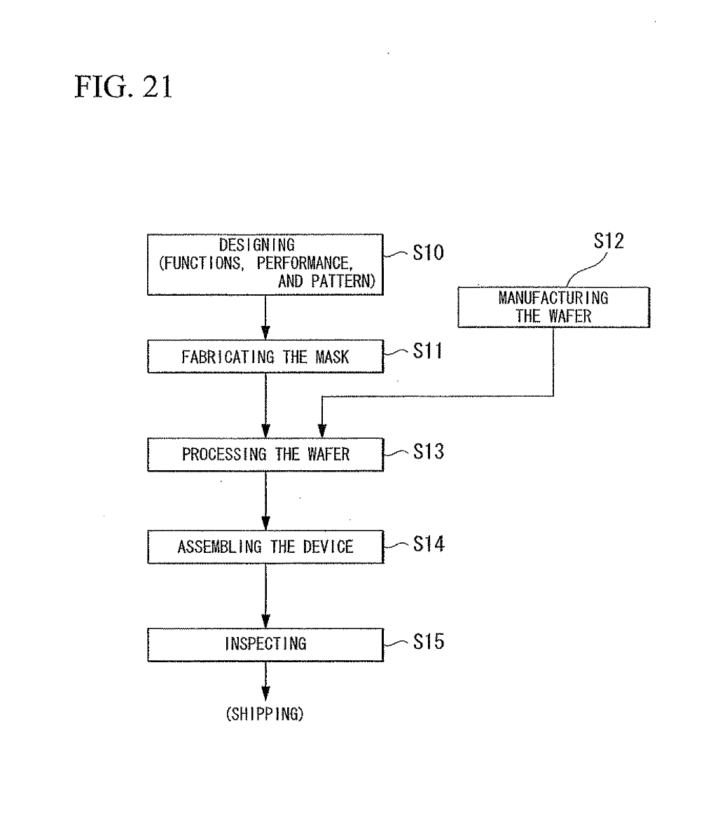

The following text explains an embodiment of a method of fabricating microdevices using the exposure apparatus 100 and the exposing method according to the embodiments of the present invention in a lithographic process. FIG. 21 depicts a flow chart of an example of fabricating a microdevice (i.e., a semiconductor chip such as an IC or an LSI; a liquid crystal panel; a CCD; a thin film magnetic head; a micromachine; and the like).

First, in a step S10 (i.e., a designing step), the functions and performance of the microdevice (e.g., the circuit design of the semiconductor device), as well as the pattern for implementing those functions, are designed. Next, in a step S11 (i.e., a mask fabricating step), the mask (i.e., the reticle), wherein the designed circuit pattern is formed, is fabricated. Moreover, in a step S12 (i.e., a wafer manufacturing step), the wafer is manufactured using a material such as silicon.

Next, in a step S13 (i.e., a wafer processing step), the actual circuit and the like are formed on the wafer by, for example, lithographic technology (discussed later) using the mask and the wafer that were prepared in the steps S10-S12. Then, in a step S14 (i.e., a device assembling step), the device is assembled using the wafer that was processed in the step S13. In the step S14, processes are included as needed, such as the dicing, bonding, and packaging (i.e., chip encapsulating) processes. Lastly, in a step S15 (i.e., an inspecting step), inspections are performed, for example, an operation verification test and a durability test of the microdevice fabricated in the step S14. Finishing such processes completes the fabrication of the microdevice, which is then shipped.

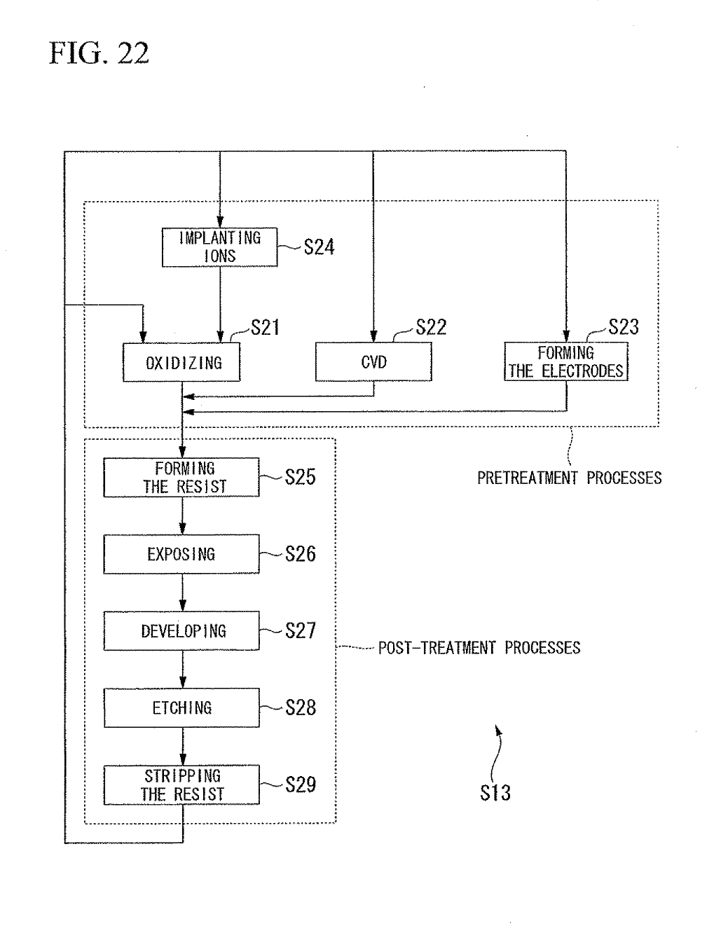

FIG. 22 depicts one example of the detailed process of the step S13 for the case of a semiconductor device.

In a step S21 (i.e., an oxidizing step), the front surface of the wafer W is oxidized. In a step S22 (i.e., a CVD step), an insulating film is formed on the front surface of the wafer. In a step S23 (i.e., an electrode forming step), an electrode is formed on the wafer by vacuum deposition. In a step S24 (i.e., an ion implanting step), ions are implanted in the wafer. The above steps S21-S24 constitute the pretreatment processes of the various stages of wafer processing and are selectively performed in accordance with the processes needed in the various stages.

When the pretreatment processes discussed above in each stage of the wafer process are complete, post-treatment processes are performed as described below. In the post-treatment processes, the wafer is first coated with a photosensitive agent in a step S25 (i.e., a resist forming step). Continuing, in a step S26 (i.e., an exposing step), the circuit pattern of the mask is transferred onto the wafer by the lithography system (i.e., the exposure apparatus) and the exposing method explained above. Next, in a step S27 (i.e., a developing step), the exposed wafer is developed; further, in a step S28 (i.e., an etching step), the uncovered portions are removed by etching, excluding the portions where the resist remains. Further, in a step S29 (i.e., a resist stripping step), etching is finished and the resist that is no longer needed is stripped. Circuit patterns are superposingly formed on the wafer by repetitively performing the pretreatment and post-treatment processes.

### INDUSTRIAL FIELD OF APPLICATION

As explained above, the moving body apparatus of the present invention is suitable for driving a moving body within a prescribed plane. In addition, the exposure apparatus and the exposing method of the present invention are suitable for forming a pattern on an object by radiating an energy beam thereto. In addition, the device fabricating method of the present invention is suitable for fabricating electronic devices.

1. An exposure apparatus that exposes an object with an energy beam through an optical system and a liquid, comprising:
a first moving body, which comprises guide members that extend in a first direction, that moves in a second direction, which is substantially orthogonal to the first direction, by the drive of a first drive apparatus;
two second moving bodies, which are provided such that they are capable of moving independently in the first direction along the guide members, that move in the second direction together with the guide members by the movement of the first moving body;
a holding member, which holds the object and is supported by the two second moving bodies such that it is capable of moving within a two dimensional plane that includes at least the first direction and the second direction as well as a first position directly below the optical system; and
a liquid holding member that is disposed adjacent to the two second moving bodies in the second direction, moves together with the holding member, which is supported by the two second moving bodies, in a direction parallel to the second direction by the drive of a second drive apparatus, which shares at least one part of the first drive apparatus, while maintaining the state wherein the liquid holding member is in close proximity or in contact at its end part on one of the second direction sides, and causes a transition from a first state, wherein the liquid is held between the object on the holding member and the optical system, to a second state, wherein the liquid is held between the liquid holding member and the optical system.

2. The exposure apparatus according to claim 1, wherein
the liquid holding member is provided to the first moving body and moves in the second direction by the drive of the first drive apparatus.

3. The exposure apparatus according to claim 1, wherein
the first drive apparatus comprises a stator, which comprises a body selected from the group consisting of a magnetism generating body and a coil body, and a slider, which comprises the other body, is connected to the first moving body, and moves relative to the stator in the second direction; and
the second drive apparatus shares the stator and comprises a second slider, which is connected to the liquid holding member and moves relative to the stator in the second direction.

4. The exposure apparatus according to claim 3, wherein
the liquid holding member is provided to a measurement stage, which comprises a measuring apparatus wherein a measurement is performed related to the exposure of the object, and moves in the second direction by the drive of the second drive apparatus.

5. The exposure apparatus according to claim 1, comprising:
a first measuring apparatus that measures in a third direction, which are substantially orthogonal to the two dimensional plane, a first gap between the holding member and the liquid holding member; and
a first adjusting apparatus that adjusts the first gap based on a measurement result of the first measuring apparatus.

6. The exposure apparatus according to claim 5, wherein
when the holding member and the liquid holding member have been brought into close proximity with one another, the first adjusting apparatus adjusts in the third direction the position of at least one member selected from the group consisting of the holding member and the liquid holding member.

7. The exposure apparatus according to claim 5, further comprising:
a second measuring apparatus, which measures in the second direction a second gap between the holding member and the liquid holding member; and
a second adjusting apparatus, which adjusts the second gap based on a measurement result of the second measuring apparatus.

8. The exposure apparatus according to claim 1, wherein
a plurality of stage units, each stage unit comprising the first moving body and the two second moving bodies, is provided; and
the holding member is capable of moving alternately between the stage units.

9. The exposure apparatus according to claim 8, further comprising:
a position measuring system, which measures the position at least within the two dimensional plane of the holding member supported by the second moving bodies;
wherein,
each of the stage units of the plurality of stage units has a space that is formed between the two second moving bodies and that passes therethrough in the second direction;
a measurement surface is provided to one surface of the holding member that is substantially parallel to the two dimensional plane;
the position measuring system comprises a measuring arm, which has a cantilevered support structure extending in the second direction, that comprises a head, part of which is disposed opposing the measurement surface in the space of one of the stage units of the plurality of stage units, that radiates at least one measurement beam to the measurement surface and receives light of the measurement beam reflected from the measurement surface, the other side of the measuring arm in a direction parallel to the second direction serving as a fixed end; and
the position measuring system measures the position at least within the two dimensional plane of the holding member held by one of the stage units of the plurality of stage units based on the output of the head.

10. The exposure apparatus according to claim 9, wherein
at least part of the holding member is a solid part wherethrough the light can travel;
the measurement surface is disposed on the object mounting surface side of the holding member such that the measurement surface opposes the solid part; and
the head is disposed on a side opposite the object mounting surface such that the head opposes the solid part.

11. The exposure apparatus according to claim 9, wherein
a grating is formed in the measurement surface; and
the head radiates at least one measurement beam to the grating and receives a diffracted light of the measurement beam from the grating.

12. The exposure apparatus according to claim 11, wherein
the grating comprises first and second diffraction gratings, whose direction of periodicity are oriented in the first direction and the second direction, which are perpendicular to the first direction within the two dimensional plane, respectively;
the head radiates a first direction measurement beam and a second direction measurement beam corresponding to the first and second diffraction gratings as the measurement beams and receives diffracted lights of the first direction measurement beam and the second direction measurement beam from the grating; and
the position measuring system measures the position of the holding member in the first and second directions based on the outputs of the head.

13. A device fabricating method comprising:
exposing an object using an exposure apparatus according to claim 1, and
developing the exposed object.
